(19) United States
(12) Patent Application Publication
(10) Pub. No.: US 2024/0329553 A1
(43) Pub. Date: Oct. 3, 2024

(54) TONER SET, ELECTROSTATIC IMAGE DEVELOPER SET, TONER CARTRIDGE SET, PROCESS CARTRIDGE, IMAGE FORMING APPARATUS, IMAGE FORMING METHOD, AND PRINTED MATERIAL

(71) Applicant: FUJIFILM BUSINESS INNOVATION CORP., Tokyo (JP)

(72) Inventors: Kohei MANABE, Kanagawa (JP); Yukiaki NAKAMURA, Kanagawa (JP); Takahisa TATEKAWA, Kanagawa (JP)

(73) Assignee: FUJIFILM BUSINESS INNOVATION CORP., Tokyo (JP)

(21) Appl. No.: 18/586,945

(22) Filed: Feb. 26, 2024

(30) Foreign Application Priority Data
Mar. 29, 2023 (JP) 2023-054183

(51) Int. Cl. G03G 9/09; G03G 9/08; G03G 15/01

(52) U.S. Cl. CPC G03G 9/0926; G03G 9/0819; G03G 15/0184

(57) ABSTRACT

A toner set includes two colors of fluorescent toners. A difference between wavelengths of fluorescent light emitted by the two colors of fluorescent toners is 50 nm or more, and at least one of the two colors of fluorescent toners includes only an aggregation-induced emission colorant serving as a fluorescent colorant.

### CROSS-REFERENCE TO RELATED APPLICATIONS

This application is based on and claims priority under 35 USC 119 from Japanese Patent Application No. 2023-054183 filed Mar. 29, 2023.

### BACKGROUND

### (i) Technical Field

The present disclosure relates to a toner set, an electrostatic image developer set, a toner cartridge set, a process cartridge, an image forming apparatus, an image forming method, and a printed material.

### (ii) Related Art

Japanese Unexamined Patent Application Publication No. 2010-072643 discloses a toner set including a plurality of toners, at least one toner but less than all toners of the toner set including a binder, a coloring agent, and a fluorescence agent, remaining toners including a binder and a coloring agent and being free of a fluorescence agent, wherein at least a first toner grouping and a second toner grouping of the toner set form a combination, the first and second toner groupings of the combination exhibiting a substantially same color under ambient light conditions upon image formation, the first and second toner groupings of the combination containing different amounts of the fluorescence agent, wherein upon exposure to activating energy, the fluorescence agent fluoresces to cause a visible change in the color of a pattern formed in an image by the first toner grouping compared with the second toner grouping.

Japanese Unexamined Patent Application Publication No. 2020-118896 discloses an image forming apparatus that includes a first image formation unit that forms a clear toner image with a clear toner, a second image formation unit that forms a color toner image with a color toner, a transfer unit that transfers at least one of the clear toner image and the color toner image to a medium, and a controller that controls the formation of the clear toner image and the color toner image. In Japanese Unexamined Patent Application Publication No. 2020-118896, a fluorescent cyan toner, a fluorescent magenta toner, a fluorescent yellow toner, and the like are described as examples of the color toner that can be used in the image forming apparatus.

### SUMMARY

Aspects of non-limiting embodiments of the present disclosure relate to a toner set capable of reducing the color difference of an image formed using the toner set which occurs when the image is stored at high temperatures, compared with the case where the toner set includes two colors of fluorescent toners, the difference between the wavelengths of fluorescent light emitted by the two colors of fluorescent toners is 50 nm or more, and both of the two colors of fluorescent toners include a fluorescent dye as a fluorescent colorant.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a toner set including two colors of fluorescent toners, wherein a difference between wavelengths of fluorescent light emitted by the two colors of fluorescent toners is 50 nm or more, and at least one of the two colors of fluorescent toners includes only an aggregation-induced emission colorant serving as a fluorescent colorant.

### BRIEF DESCRIPTION OF THE DRAWINGS

Exemplary embodiments of the present disclosure will be described in detail based on the following figures, wherein:

FIG. 1 is a schematic diagram illustrating an example of an image forming apparatus according to an exemplary embodiment of the disclosure; and

FIG. 2 is a schematic diagram illustrating an example of a process cartridge detachably attachable to the image forming apparatus according to an exemplary embodiment of the disclosure.

### DETAILED DESCRIPTION

Exemplary embodiments of the present disclosure are described below. It should be noted that the following description and Examples are illustrative of the exemplary embodiments but not restrictive of the scope of the exemplary embodiments.

In the present disclosure, a numerical range expressed using “to” means the range that includes the values described before and after “to” as the minimum and maximum values, respectively.

In the present disclosure, when numerical ranges are described in a stepwise manner, the upper or lower limit of a numerical range may be replaced with the upper or lower limit of another numerical range, respectively. In the present disclosure, the upper or lower limit of a numerical range may also be replaced with a value described in Examples below.

In the present disclosure, the term “step” refers not only to an individual step but also to a step that is not distinguishable from other steps but achieves the intended purpose of the step.

In the present disclosure, when an exemplary embodiment is described with reference to a drawing, the structure of the exemplary embodiment is not limited to the structure illustrated in the drawing. The sizes of the members illustrated in the attached drawing are conceptual and do not limit the relative relationship among the sizes of the members.

Each of the components described in the present disclosure may include a plurality of types of substances that correspond to the component. In the present disclosure, in the case where a composition includes a plurality of substances that correspond to a component of the composition, the content of the component in the composition is the total content of the substances in the composition unless otherwise specified.

Each of the components described in the present disclosure may include a plurality of types of particles that correspond to the component. In the case where a composition includes a plurality of particles that correspond to a component of the composition, the size of particles of the component is the size of particles of a mixture of the plurality of particles included in the composition unless otherwise specified.

In the present disclosure, the term “(meth) acryl” refers to both “acryl” and “methacryl”, and the term “(meth) acrylate” refers to both “acrylate” and “methacrylate”.

In the present disclosure, “electrostatic image developer” and “electrostatic image developing carrier” are also referred to as “developer” and “carrier”, respectively.

### Toner Set

A toner set according to an exemplary embodiment of the disclosure is a toner set including two colors of fluorescent toners, wherein a difference between wavelengths of fluorescent light emitted by the two colors of fluorescent toners is 50 nm or more, and at least one of the two colors of fluorescent toners includes only an aggregation-induced emission colorant serving as a fluorescent colorant.

In the present disclosure, the term “aggregation-induced emission colorant” refers to a colorant having a property of fluorescing when a number of molecules of the colorant are aggregated together to form a crystalline state (i.e., an aggregated state) although a molecule of the colorant does not fluoresce alone, that is, capable of aggregation-induced emission (AIE).

An aggregation-induced emission colorant is different from a fluorescent dye, a molecule of which is capable of emitting light alone upon receiving light energy from the outside.

Note that, in the present disclosure, the term “fluorescent dye” also refers to a fluorescent pigment produced by dispersing a fluorescent dye in a resin (hereinafter, such a pigment is also referred to as “pigmented fluorescent dye”) and a fluorescent brightening agent.

The wavelength of fluorescent light emitted by a fluorescent toner is measured in the following manner.

A modification of an image forming apparatus “Revoria Press PC1120” produced by FUJIFILM Business Innovation Corp. is prepared. A sample toner is charged into a magenta developer. A solid image having an area coverage of 100% (toner deposition density: 4.0 g/m²) is formed on an OS coated paper sheet “OS Coat W” (127 g/m²) produced by FUJIFILM Business Innovation Corp. with the sample toner at a temperature of 22° C. and a humidity of 55% RH.

The spectral reflection spectrum of the solid image in the visible region is measured using a reflection spectrodensitometer “X-Rite 939” (aperture diameter: 4 mm) produced by X-Rite, Inc. at 10 positions randomly selected from the image, and the average thereof is calculated.

The wavelength (i.e., emission peak wavelength) at which the highest spectral reflectance occurs in the spectral reflection spectrum is considered as the wavelength of fluorescent light emitted by the fluorescent toner.

There are some colors that cannot be reproduced by simply combining cyan, magenta, and yellow, which are referred to as “fundamental colors”, with one another in printing (i.e., image formation) using toners. Accordingly, there has been an approach to widening the color gamut of an image by using a special color, such as a fluorescent color, in combination with cyan, magenta, and yellow. For example, using two colors of fluorescent toners having different hues in combination with cyan, magenta, and yellow widens color gamut.

A fluorescent toner commonly includes a fluorescent dye (including a pigmented fluorescent dye and a fluorescent brightening agent as described above) as a fluorescent colorant. Since a fluorescent dye is present in the form of molecules in toner particles, the Brownian motion of the molecules is large. When the toner particles are softened by heat, the fluorescent dye is likely to migrate inside the toner.

In the portion of a toner image in which two colors of fluorescent toners overlap each other, fluorescent color forming property may become degraded when the toner image is stored at high temperatures. This may result in color muddiness or dullness. It is considered that the above phenomenon occurs because the association or proximity of the different types of fluorescent dyes included in the two colors of fluorescent toners causes intermolecular energy transfer, which significantly degrades the fluorescent emission of one of the fluorescent toners. It is also considered that the above phenomenon occurs particularly because it is desirable to arrange a fluorescent toner in the upper layer of the toner image in consideration of color forming property and, when a toner image is formed using two or more colors of fluorescent toners, two colors of layers including the fluorescent toners are brought into contact with each other disadvantageously.

Note that the color difference of the image which occurs when the image is stored at high temperatures is present in the case where the two colors of toners include different types of fluorescent dyes; the above color difference is unlikely to occur in the case where one of the two toners includes a nonfluorescent dye.

A toner set according to an exemplary embodiment of the disclosure includes two colors of fluorescent toners, wherein a difference between wavelengths of fluorescent light emitted by the two colors of fluorescent toners is 50 nm or more, and at least one of the two colors of fluorescent toners includes only an aggregation-induced emission colorant serving as a fluorescent colorant.

Since the above toner set includes two colors of fluorescent toners, wherein a difference between wavelengths of fluorescent light emitted by the two colors of fluorescent toners is 50 nm or more, the color gamut of an image may be widened.

Furthermore, since the aggregation-induced emission colorant is present in particles of the fluorescent toner including an aggregation-induced emission colorant, for example, in the state of crystals having a size of several hundred nanometers (i.e., an aggregated state), the aggregation-induced emission colorant is unlikely to migrate even when the toner particles are softened by heat. It is considered that this reduces the frequency at which the aggregation-induced emission colorant is brought into contact with another fluorescent colorant in the portion of the toner image in which two colors of fluorescent toners overlap each other. In addition, since the aggregation-induced emission colorant included in the toner particles is in a crystalline state, it has a larger particle size than a fluorescent dye. This may reduce the association of the aggregation-induced emission colorant with the fluorescent dye. For the above-described reasons, when at least one of the two colors of fluorescent toners includes only an aggregation-induced emission colorant serving as a fluorescent colorant, the color difference of an image formed using the toner set which occurs when the image is stored at high temperatures may be reduced.

### Preferable Aspects

In the toner set according to an exemplary embodiment of the disclosure, the content A of the aggregation-induced emission colorant in the fluorescent toner is preferably 1% by mass or more and 20% by mass or less, is more preferably 3% by mass or more and 17.5% by mass or less, and is further preferably 5% by mass or more and 15% by mass or less in order to further reduce the color difference of an image formed using the toner set which occurs when the image is stored at high temperatures and increase the emission intensity of the image.

In the toner set according to an exemplary embodiment of the disclosure, it is preferable that one of the two colors of fluorescent toners be a fluorescent toner including a fluorescent dye and free of the aggregation-induced emission colorant, that the content B of the fluorescent dye in the fluorescent toner including a fluorescent dye and free of the aggregation-induced emission colorant be 0.1% by mass or more and 5% by mass or less, and that the content A of the aggregation-induced emission colorant and the content B of the fluorescent dye satisfy A>B in order to further reduce the color difference of an image formed using the toner set which occurs when the image is stored at high temperatures.

In other words, when one of the two colors of fluorescent toners is a fluorescent toner T_{A} that includes an aggregation-induced emission colorant and the other fluorescent toner is a fluorescent toner T_{B} that includes a fluorescent dye and free of the aggregation-induced emission colorant, the content B of the fluorescent dye in the fluorescent toner T_{B} including a fluorescent dye and free of the aggregation-induced emission colorant is preferably 0.1% by mass or more and 5% by mass or less and the content A of the aggregation-induced emission colorant and the content B of the fluorescent dye preferably satisfy A>B.

The content B of the fluorescent dye in the fluorescent toner T_{B} including a fluorescent dye and free of the aggregation-induced emission colorant is more preferably 0.3% by mass or more and 4% by mass or less and is further preferably 0.5% by mass or more and 3% by mass or less.

The content A of the aggregation-induced emission colorant in the fluorescent toner and the content B of the fluorescent dye in the fluorescent toner including a fluorescent dye and free of the aggregation-induced emission colorant are determined by the following method.

When the content A of an aggregation-induced emission colorant in toner particles is measured, the toner that is to be analyzed is dispersed in water including a surfactant. Subsequently, an ultrasonic wave treatment is performed in order to remove an external additive from the toner particles. The toner particles are then charged into an Erlenmeyer flask. Tetrahydrofuran (THF) is further charged into the flask. Subsequently, the flask is hermetically sealed and left to stand for 24 hours. The contents of the flask are then transferred into a glass centrifuge tube. THF is again charged into the Erlenmeyer flask to clean the flask and then transferred into the glass centrifuge tube. Subsequently, the glass centrifuge tube is hermetically sealed and centrifuged for 30 minutes at a rotation speed of 20,000 rpm and a temperature of −10° C. After centrifugation has been done, the contents are removed from the tube and left to stand. Subsequently, the supernatant is removed to obtain the aggregation-induced emission colorant, which is insoluble in THF. After THF has been completely removed by drying, the weight of the aggregation-induced emission colorant is measured.

The content B of a fluorescent dye in toner particles is determined in the following manner. One gram of the toner is weighed. To the toner, 20 mL of tetrahydrofuran (THF) is added. The resulting mixture is subjected to an ultrasonic wave treatment for 15 minutes. Subsequently, 60 mL of acetonitrile is added to the mixture. After the mixture has been left to stand for 60 minutes, it is centrifuged at 20,000 rpm and 4° C. for 30 minutes and the supernatant is sampled. The supernatant is filtered through a 0.2-μm filter. Then, 0.1 ml of octyl phenol is added to the supernatant to prepare a measurement sample. The measurement sample is analyzed with a liquid chromatograph mass spectrometer “LCMS-IT-TOF” produced by Shimadzu Corporation. The amount of the fluorescent dye included in the toner is determined on the basis of the peak intensity and waveform separation.

In the toner set according to an exemplary embodiment of the disclosure, the volume average particle size of the aggregation-induced emission colorant included in the fluorescent toner is preferably 100 nm or more and 1,000 nm or less, is more preferably 150 nm or more and 500 nm or less, and is further preferably 200 nm or more and 400 nm or less in order to further reduce the color difference of an image formed using the toner set which occurs when the image is stored at high temperatures and increase the emission intensity of the image.

The volume average particle size of the aggregation-induced emission colorant included in the fluorescent toner is determined in the following manner.

The sizes of particles of the aggregation-induced emission colorant removed from the toner by the above-described method for determining the content A of the aggregation-induced emission colorant in the fluorescent toner are measured with a laser diffraction scattering particle size distribution analyzer (e.g., “Microtrac MT3000II” produced by MicrotracBEL Corp.). The number of the particles of the aggregation-induced emission colorant is at least 3,000. The volume basis particle size distribution of the aggregation-induced emission colorant is determined. The particle size at which the cumulative volume calculated in ascending order in terms of particle size reaches 50% is considered as the volume average particle size. This volume average particle size is used as the volume average size of particles of the aggregation-induced emission colorant included in the fluorescent toner.

In the toner set according to an exemplary embodiment of the disclosure, it is preferable that one of the two colors of fluorescent toners be a fluorescent toner including a fluorescent dye and free of the aggregation-induced emission colorant, and the fluorescent dye included in the fluorescent toner including a fluorescent dye and free of the aggregation-induced emission colorant have a molecular weight of 400 or more in order to further reduce the color difference of an image formed using the toner set which occurs when the image is stored at high temperatures.

In other words, when one of the two colors of fluorescent toners is a fluorescent toner T_{A} that includes an aggregation-induced emission colorant and the other fluorescent toner is a fluorescent toner T_{B} that includes a fluorescent dye and free of the aggregation-induced emission colorant, the fluorescent dye included in the fluorescent toner T_{B} including a fluorescent dye and free of the aggregation-induced emission colorant preferably has a molecular weight of 400 or more.

In the toner set according to an exemplary embodiment of the disclosure, the ½-drop temperatures of the two colors of fluorescent toners which are measured with a flow tester are preferably 90° C. or more, are more preferably 100° C. or more, and are further preferably 110° C. or more in order to further reduce the color difference of an image formed using the toner set which occurs when the image is stored at high temperatures.

Note that the upper limit for the ½-drop temperatures of the two colors of fluorescent toners which are measured with a flow tester is, for example, 140° C. or less.

The ½-drop temperature of a fluorescent toner is determined with a flow tester in the following manner.

A Koka flow tester “CFT-500C” produced by Shimadzu Corporation is used. With a die having an orifice having a diameter of 0.5 mm and a length of 1 mm, at a test pressure of 0.98 MPa (10 kg/cm²), a preheating time of 5 minutes, a heating rate of 1° C./min, a measurement temperature interval of 1° C., and a start temperature of 65° C., 1.1 g of the fluorescent toner is discharged in a molten state. The temperature that corresponds to the level that is the midpoint between the starting and end points of discharge is determined.

Details of the toners included in the toner set according to an exemplary embodiment of the disclosure are described below.

### Toner Set Including Two Colors of Fluorescent Toners

The toner set according to an exemplary embodiment of the disclosure includes two colors of fluorescent toners. The difference between wavelengths of fluorescent light emitted by the two colors of fluorescent toners is 50 nm or more. At least one of the two colors of fluorescent toners includes only an aggregation-induced emission colorant serving as a fluorescent colorant.

The toner set according to an exemplary embodiment of the disclosure may include a toner other than any of the two colors of fluorescent toners (hereinafter, such a toner is also referred to as “other toner”).

Examples of the other toner include a toner that includes a nonfluorescent colorant (e.g., specifically, a nonfluorescent pigment or dye).

The other toner may be a fluorescent toner other than any of the two colors of fluorescent toners. In other words, the toner set according to an exemplary embodiment of the disclosure may include three or more colors of fluorescent toners. In the case where the toner set according to an exemplary embodiment of the disclosure includes three or more colors of fluorescent toners, at least two of the fluorescent toners include only an aggregation-induced emission colorant serving as a fluorescent colorant.

Examples of the fluorescent toner include fluorescent green, pink, red, orange, yellow, blue, and purple toners.

Examples of the toner that includes a nonfluorescent pigment or dye include yellow, cyan, magenta, black, red, green, blue, orange, and violet toners.

In particular, in order to increase ease of formation of full-color images, the toner set according to an exemplary embodiment of the disclosure preferably includes yellow, cyan, and magenta toners and more preferably includes yellow, cyan, magenta, and black toners, which serve as other toners.

### Toner Particles

The two colors of fluorescent toners each include toner particles including a fluorescent colorant.

The toner particles include a fluorescent colorant that serves as a coloring agent and a binder resin and may include a release agent and other additives as needed.

In consideration of toning, the toner particles may include a nonfluorescent pigment that serves as a coloring agent in combination with a fluorescent colorant.

### Fluorescent Colorant

Examples of the fluorescent colorant that may be included in the toner set according to an exemplary embodiment of the disclosure include an aggregation-induced emission colorant and a fluorescent dye.

### Aggregation-Induced Emission Colorant

The aggregation-induced emission colorant is not limited and may be any colorant having the above-described property.

Specific examples of the aggregation-induced emission colorant include C. I. Pigment Yellow 101, a boron difluoride derivative of C. I. Pigment Yellow 101, and 1,2,3,4-tetrachloro-11H-isoindolo[2,1-a]benzimidazol-11-one.

Among these, C. I. Pigment Yellow 101 is preferably used as an aggregation-induced emission colorant in consideration of chroma and fluorescence intensity.

Note that 1,2,3,4-tetrachloro-11H-isoindolo[2,1-a]benzimidazol-11-one is available as “RADGLO VSF-0-05” produced by Radiant Color.

### Fluorescent Dye

The fluorescent dye is not limited.

Examples of the fluorescent dye include fluorescent dyes that belong to the following: a naphthalimide; a cationic or noncationic coumarin; a xanthenodiquinolizine (e.g., a sulforhodamine); an azaxanthene; a naphtholactam; an azlactone; an oxazine; a thiazine; a dioxazine; and an azo, azomethine, or methine-type monocationic or polycationic fluorescent dye or a mixture thereof.

The molecular weight of the fluorescent dye may be 400 or more as described above. The higher the molecular weight of the fluorescent dye, the lower the likelihood of the fluorescent dye migrating inside the fluorescent toner. Accordingly, the molecular weight of the fluorescent dye may be 400 or more in order to further reduce the color difference of an image formed using the toner set which occurs when the image is stored at high temperatures.

Examples of the fluorescent dye include a fluorescent dye having a cationic group.

The cationic group is preferably an onium group, is more preferably an ammonium group, an iminium group, or a pyridinium group, is further preferably an ammonium group, and is particularly preferably a quaternary ammonium group in consideration of fluorescence intensity.

The number of cationic groups included in the fluorescent dye may be only one or two or more. The number of cationic groups included in the fluorescent dye is preferably 1 to 4, is more preferably 1 or 2, and is particularly preferably 1 in consideration of fluorescence intensity.

Specific examples of the fluorescent dye include C. I. Basic Red 1 (Rhodamine 6G), C. I. Basic Red 1:1, C. I. Basic Red 2, C. I. Basic Red 12, C. I. Basic Red 13, C. I. Basic Red 14, C. I. Basic Red 15, C. I. Basic Red 36, C. I. Basic Violet 7, C. I. Basic Violet 10 (Rhodamine B), C. I. Basic Violet 11 (Rhodamine 3B), C. I. Basic Violet 11:1 (Rhodamine A), C. I. Basic Violet 15, C. I. Basic Violet 16, C. I. Basic Violet 27, C. I. Basic Yellow 1, C. I. Basic Yellow 2, C. I. Basic Yellow 9, C. I. Basic Yellow 24, C. I. Basic Yellow 40, C. I. Basic Orange 15, C. I. Basic Orange 22, C. I. Basic Blue 1, C. I. Basic Blue 3, C. I. Basic Blue 7, C. I. Basic Blue 9, C. I. Basic Blue 45, C. I. Basic Green 1, C. I. Acid Yellow 3, C. I. Acid Yellow 7, C. I. Acid Yellow 73, C. I. Acid Yellow 87, C. I. Acid Yellow 184, C. I. Acid Yellow 245, C. I. Acid Yellow 250, C. I. Acid Red 51, C. I. Acid Red 52, C. I. Acid Red 57, C. I. Acid Red 77, C. I. Acid Red 87, C. I. Acid Red 89, C. I. Acid Red 92, C. I. Acid Blue 9, C. I. Acid Black 2, C. I. Solvent Yellow 43, C. I. Solvent Yellow 44, C. I. Solvent Yellow 85, C. I. Solvent Yellow 98, C. I. Solvent Yellow 116, C. I. Solvent Yellow 131, C. I. Solvent Yellow 145, C. I. Solvent Yellow 160:1, C. I. Solvent Yellow 172, C. I. Solvent Yellow 185, C. I. Solvent Yellow 195, C. I. Solvent Yellow 196, C. I. Solvent Orange 63, C. I. Solvent Orange 112, C. I. Solvent Red 49, C. I. Solvent Red 149, C. I. Solvent Red 175, C. I. Solvent Red 196, C. I. Solvent Red 197, C. I. Solvent Blue 5, C. I. Solvent Green 5, C. I. Solvent Green 7, C. I. Direct Yellow 27, C. I. Direct Yellow 85, C. I. Direct Yellow 96, C. I. Direct Orange 8, C. I. Direct Red 2, C. I. Direct Red 9, C. I. Direct Blue 22, C. I. Direct Blue 199, C. I. Direct Green 6, C. I. Disperse Yellow 11, C. I. Disperse Yellow 82, C. I. Disperse Yellow 139, C. I. Disperse Yellow 184, C. I. Disperse Yellow 186, C. I. Disperse Yellow 199, C. I. Disperse Yellow 202, C. I. Disperse Yellow 232, C. I. Disperse Orange 11, C. I. Disperse Orange 32, C. I. Disperse Red 58, C. I. Disperse Red 274, C. I. Disperse Red 277, C. I. Disperse Red 303, C. I. Disperse Blue 7, C. I. Reactive Yellow 78, and C. I. Vat Red 41.

As described above, a fluorescent pigment produced by dispersing a fluorescent dye in a resin (i.e., pigmented fluorescent dye) is also considered as a fluorescent dye.

Examples of the pigmented fluorescent dye include resin particles produced by dispersing the various fluorescent dyes described above in resins, such as a melamine resin, an alkyd resin, a vinyl chloride resin, an acrylic resin, a polyester resin, an amino resin, a formaldehyde-condensed resin, and the like.

Examples of the pigmented fluorescent dye include powder fluorescent pigments produced by SINLOIHI CO., LTD. (SINLOIHI COLOR SX-100 Series, SX-200 Series, SX-300 Series, NEZ-100 Series, etc.), fluorescent pigments produced by Day-Glo Color Corp. (T Series, GT Series, ZQ Series, GPL Series, etc.), and fluorescent pigments produced by Nippon Fluorescent Chemical Co., Ltd. (e.g., NKV-S Series and NKW-3200E Series).

The fluorescent dye may be a fluorescent brightening agent.

Examples of the fluorescent brightening agent include a benzoxazole derivative, a benzothiazole derivative, a benzimidazole derivative, a stilbene derivative, a coumarin derivative, a biphenyl derivative, a naphthalimide derivative, and a benzidine derivative. Specific examples thereof include Fluorescent Brightener 184 and Fluorescent Brightener 393.

The number of types of the fluorescent dyes included in the toner particles including a fluorescent dye may be only one or two or more. The number of types of the fluorescent dyes may be only one in consideration of the lightness and chroma of the images formed using the toner set.

### Nonfluorescent Colorant

### Nonfluorescent Pigment

The color, etc. of the nonfluorescent pigment are not limited; the nonfluorescent pigment may be any pigment that does not have fluorescence. Examples of the nonfluorescent pigment include nonfluorescent green, red, yellow, pink, orange, and purple pigments.

Examples of the nonfluorescent pigment include the following pigments: carbon black, chrome yellow, Hansa Yellow, Benzidine Yellow, threne yellow, quinoline yellow, Pigment Yellow, Permanent Orange GTR, Pyrazolone Orange, Vulcan Orange, Watch Young Red, Permanent Red, Brilliant Carmine 3B, Brilliant Carmine 6B, Dupont Oil Red, Pyrazolone Red, Lithol Red, Rhodamine B Lake, Lake Red C, Pigment Red, Pigment Orange, Rose Bengal, aniline blue, ultramarine blue, Calco Oil Blue, methylene blue chloride, phthalocyanine blue, Pigment Blue, phthalocyanine green, Malachite green oxalate, titanium oxide, zinc oxide, calcium carbonate, basic lead carbonate, a zinc sulfate-barium sulfate mixture, zinc sulfate, silicon dioxide, and aluminum oxide.

Specific examples of the nonfluorescent pigment include:
C. I. Pigment Yellow 1 (since the following pigments are all “C. I. Pigment Yellow”, only the numbers thereof are described for the sake of simplicity), 3, 11, 12, 13, 14, 15, 16, 17, 20, 24, 31, 53, 55, 60, 61, 65, 71, 73, 74, 81, 83, 86, 93, 95, 97, 98, 99, 100, 104, 106, 108, 109, 110, 113, 114, 116, 117, 119, 120, 125, 126, 127, 128, 129, 137, 138, 139, 147, 148, 150, 151, 152, 153, 154, 155, 156, 166, 167, 168, 175, 180, and 185;
C. I. Pigment Orange 1 (since the following pigments are all “C. I. Pigment Orange”, only the numbers thereof are described for the sake of simplicity), 5, 13, 14, 16, 17, 24, 34, 36, 38, 40, 43, 46, 49, 51, 55, 59, 61, 63, 64, 71, and 73;
C. I. Pigment Violet 1 (since the following pigments are all “C. I. Pigment Violet”, only the numbers thereof are described for the sake of simplicity), 19, 23, 29, 30, 32, 36, 37, 38, 39, 40, and 50;
C. I. Pigment Red 1 (since the following pigments are all “C. I. Pigment Red”, only the numbers thereof are described for the sake of simplicity), 2, 3, 4, 5, 6, 7, 8, 9, 10, 11, 12, 14, 15, 16, 17, 18, 19, 21, 22, 23, 30, 31, 32, 37, 38, 40, 41, 42, 48:1, 48:2, 48:3, 48:4, 49:1, 49:2, 50:1, 52:1, 53:1, 57, 57:1, 57:2, 58:2, 58:4, 60:1, 63:1, 63:2, 64:1, 81:1, 83, 88, 90:1, 97, 101, 102, 104, 105, 106, 108, 112, 113, 114, 122, 123, 144, 146, 149, 150, 151, 155, 166, 168, 170, 171, 172, 174, 175, 176, 177, 178, 179, 180, 185, 187, 188, 190, 192, 193, 194, 202, 206, 207, 208, 209, 215, 216, 217, 220, 223, 224, 226, 227, 228, 238, 240, 242, 243, 245, 254, 255, 264, and 265;
C. I. Pigment Blue 1 (since the following pigments are all “C. I. Pigment Blue”, only the numbers thereof are described for the sake of simplicity), 2, 15, 15:3, 15:4, 15:6, 16, 22, 60, 64, and 66;
C. I. Pigment Green 7, C. I. Pigment Green 36, and C. I. Pigment Green 37;
C. I. Pigment Brown 23, C. I. Pigment Brown 25, C. I. Pigment Brown 26, and C. I. Pigment Brown 28; and
C. I. Pigment Black 1 and C. I. Pigment Black 7.

Examples of inorganic pigments include titanium oxide, barium sulfate, calcium carbonate, Chinese white, lead sulfate, chrome yellow (yellow), zinc yellow, red iron oxide, cadmium red, ultramarine blue, Prussian blue, chromium oxide green, cobalt green, amber, titanium black, synthetic iron black, and carbon black.

The number of types of the nonfluorescent pigments included in the toner particles may be only one or two or more.

The content of the nonfluorescent pigment is preferably 0.5% by mass or more and 20% by mass or less, is more preferably 1% by mass or more and 15% by mass or less, and is further preferably 3% by mass or more and 10% by mass or less of the total amount of the toner particles in consideration of toning.

### Nonfluorescent Dye

The toner particles may include a nonfluorescent dye as needed.

The color, etc. of the nonfluorescent dye are not limited; any dye that does not have fluorescence may be used. Examples of the nonfluorescent dye include nonfluorescent green, red, yellow, pink, orange, and purple dyes.

### Binder Resin

Examples of the binder resin include vinyl resins that are homopolymers of the following monomers or copolymers of two or more monomers selected from the following monomers: styrenes, such as styrene, para-chlorostyrene, and α-methylstyrene; (meth) acrylates, such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; ethylenically unsaturated nitriles, such as acrylonitrile and methacrylonitrile; vinyl ethers, such as vinyl methyl ether and vinyl isobutyl ether; vinyl ketones, such as vinyl methyl ketone, vinyl ethyl ketone, and vinyl isopropenyl ketone; and olefins, such as ethylene, propylene, and butadiene.

Examples of the binder resin further include non-vinyl resins, such as epoxy resins, polyester resins, polyurethane resins, polyamide resins, cellulose resins, polyether resins, and modified rosins; a mixture of the non-vinyl resin and the vinyl resin; and a graft polymer produced by polymerization of the vinyl monomer in the presence of the non-vinyl resin.

The above binder resins may be used alone or in combination of two or more.

A polyester resin may be suitably used as a binder resin.

Examples of the polyester resin include the polyester resins known in the related art.

Examples of the polyester resin include condensation polymers of a polyvalent carboxylic acid and a polyhydric alcohol. The polyester resin may be a commercially available one or a synthesized one.

Examples of the polyvalent carboxylic acid include aliphatic dicarboxylic acids, such as oxalic acid, malonic acid, maleic acid, fumaric acid, citraconic acid, itaconic acid, glutaconic acid, succinic acid, alkenyl succinic acid, adipic acid, and sebacic acid; alicyclic dicarboxylic acids, such as cyclohexanedicarboxylic acid; aromatic dicarboxylic acids, such as terephthalic acid, isophthalic acid, phthalic acid, and naphthalenedicarboxylic acid; anhydrides of these dicarboxylic acids; and lower (e.g., 1 to 5 carbon atoms) alkyl esters of these dicarboxylic acids. Among these polyvalent carboxylic acids, for example, aromatic dicarboxylic acids may be used.

Trivalent or higher carboxylic acids having a crosslinked structure or a branched structure may be used as a polyvalent carboxylic acid in combination with the dicarboxylic acids. Examples of the trivalent or higher carboxylic acids include trimellitic acid, pyromellitic acid, anhydrides of these carboxylic acids, and lower (e.g., 1 to 5 carbon atoms) alkyl esters of these carboxylic acids.

The above polyvalent carboxylic acids may be used alone or in combination of two or more.

Examples of the polyhydric alcohol include aliphatic diols, such as ethylene glycol, diethylene glycol, triethylene glycol, propylene glycol, butanediol, hexanediol, and neopentyl glycol; alicyclic diols, such as cyclohexanediol, cyclohexanedimethanol, and hydrogenated bisphenol A; and aromatic diols, such as bisphenol A-ethylene oxide adduct and bisphenol A-propylene oxide adduct. Among these polyhydric alcohols, for example, aromatic diols and alicyclic diols may be used. In particular, aromatic diols may be used.

Trihydric or higher alcohols having a crosslinked structure or a branched structure may be used as a polyhydric alcohol in combination with the diols. Examples of the trihydric or higher alcohols include glycerin, trimethylolpropane, and pentaerythritol.

The above polyhydric alcohols may be used alone or in combination of two or more.

The glass transition temperature Tg of the polyester resin is preferably 50° C. or more and 80° C. or less and is more preferably 50° C. or more and 65° C. or less.

The glass transition temperature of the polyester resin is determined from a differential scanning calorimetry (DSC) curve obtained by DSC. More specifically, the glass transition temperature of the polyester resin is determined from the “extrapolated glass-transition-starting temperature” according to a method for determining glass transition temperature which is described in JIS K 7121:1987 “Testing Methods for Transition Temperatures of Plastics”.

The weight average molecular weight Mw of the polyester resin is preferably 5,000 or more and 1,000,000 or less and is more preferably 7,000 or more and 500,000 or less.

The number average molecular weight Mn of the polyester resin may be 2,000 or more and 100,000 or less.

The molecular weight distribution index Mw/Mn of the polyester resin is preferably 1.5 or more and 100 or less and is more preferably 2 or more and 60 or less.

The weight average molecular weight and number average molecular weight of the polyester resin are determined by gel permeation chromatography (GPC). Specifically, the molecular weights of the polyester resin are determined by GPC using a “HLC-8120GPC” produced by Tosoh Corporation as measuring equipment, a column “TSKgel SuperHM-M (15 cm)” produced by Tosoh Corporation, and a THF solvent. The weight average molecular weight and number average molecular weight of the polyester resin are determined on the basis of the results of the measurement using a molecular-weight calibration curve based on monodisperse polystyrene standard samples.

The polyester resin may be produced by any suitable production method known in the related art. Specifically, the polyester resin may be produced by, for example, a method in which polymerization is performed at 180° C. or more and 230° C. or less, the pressure inside the reaction system is reduced as needed, and water and alcohols that are generated by condensation are removed.

In the case where the raw materials, that is, the monomers, are not dissolved in or miscible with each other at the reaction temperature, a solvent having a high boiling point may be used as a dissolution adjuvant in order to dissolve the raw materials. In such a case, the condensation polymerization reaction is performed while the dissolution adjuvant is distilled away. In the case where a monomer having low miscibility is present, a condensation reaction of the monomers with an acid or alcohol that is to undergo a polycondensation reaction with the monomers may be performed in advance and subsequently polycondensation of the resulting polymers with the other components may be performed.

The content of the binder resin in the entire toner particles is preferably 40% by mass or more and 95% by mass or less, is more preferably 50% by mass or more and 90% by mass or less, and is further preferably 60% by mass or more and 85% by mass or less.

### Release Agent

Examples of the release agent include, but are not limited to, hydrocarbon waxes; natural waxes, such as a carnauba wax, a rice bran wax, and a candelilla wax; synthetic or mineral-petroleum-derived waxes, such as a montan wax; and ester waxes, such as a fatty-acid ester wax and a montanate wax.

The melting temperature of the release agent is preferably 50° C. or more and 110° C. or less and is more preferably 60° C. or more and 100° C. or less.

The above melting temperature is determined from the “melting peak temperature” according to a method for determining melting temperature which is described in JIS K 7121:1987 “Testing Methods for Transition Temperatures of Plastics” using a differential scanning calorimetry (DSC) curve obtained by DSC.

The content of the release agent is preferably 1% by mass or more and 20% by mass or less and is more preferably 5% by mass or more and 15% by mass or less of the total amount of the toner particles.

### Other Additives

Examples of the other additives include additives known in the related art, such as a magnetic substance, a charge-controlling agent, and an inorganic powder. These additives may be added to the toner particles as internal additives.

### Properties, Etc. of Toner Particles

The toner particles may have a single-layer structure or a “core-shell” structure constituted by a core (i.e., core particle) and a coating layer (i.e., shell layer) covering the core.

The core-shell structure of the toner particles may be constituted by, for example, a core including a binder resin and, as needed, other additives such as a coloring agent and a release agent and by a coating layer including a binder resin.

The volume average diameter D50v of the toner particles is preferably 2 μm or more and 10 μm or less and is more preferably 4 μm or more and 8 μm or less.

The various average particle sizes and various particle size distribution indices of the toner particles are measured using “COULTER MULTISIZER II” produced by Beckman Coulter, Inc. with an electrolyte “ISOTON-II” produced by Beckman Coulter, Inc. in the following manner.

A sample to be measured (0.5 mg or more and 50 mg or less) is added to 2 ml of a 5-mass % aqueous solution of a surfactant (e.g., sodium alkylbenzene sulfonate) that serves as a dispersant. The resulting mixture is added to 100 ml or more and 150 ml or less of an electrolyte.

The resulting electrolyte containing the sample suspended therein is subjected to a dispersion treatment for 1 minute using an ultrasonic disperser, and the distribution of the diameters of particles having a diameter of 2 μm or more and 60 μm or less is measured using COULTER MULTISIZER II with an aperture having a diameter of 100 μm. The number of the particles sampled is 50,000.

The particle diameter distribution measured is divided into a number of particle diameter ranges (i.e., channels). For each range, in ascending order in terms of particle diameter, the cumulative volume and the cumulative number are calculated and plotted to draw cumulative distribution curves. Particle diameters at which the cumulative volume and the cumulative number reach 16% are considered to be the volume particle diameter D16v and the number particle diameter D16p, respectively. Particle diameters at which the cumulative volume and the cumulative number reach 50% are considered to be the volume average particle diameter D50v and the number average particle diameter D50p, respectively. Particle diameters at which the cumulative volume and the cumulative number reach 84% are considered to be the volume particle diameter D84v and the number particle diameter D84p, respectively.

Using the volume particle diameters and number particle diameters measured, the volume particle size distribution index (GSDv) is calculated as (D84v/D16v)^{1/2} and the number particle size distribution index (GSDp) is calculated as (D84p/D16p)^{1/2}.

The toner particles preferably have an average circularity of 0.94 or more and 1.00 or less. The average circularity of the toner particles is more preferably 0.95 or more and 0.98 or less.

The average circularity of the toner particles is determined as [Equivalent circle perimeter]/[Perimeter] (i.e., [Perimeter of a circle having the same projection area as the particles]/[Perimeter of the projection image of the particles]. Specifically, the average circularity of the toner particles is determined by the following method.

The toner particles to be measured are sampled by suction so as to form a flat stream. A static image of the particles is taken by instantaneously flashing a strobe light. The image of the particles is analyzed with a flow particle image analyzer “FPIA-3000” produced by Sysmex Corporation. The number of samples used for determining the average circularity of the toner particles is 3,500.

In the case where the toner includes an external additive, the toner (i.e., the developer) to be measured is dispersed in water containing a surfactant and then subjected to an ultrasonic wave treatment in order to remove the external additive from the toner particles.

### External Additive

Examples of the external additive include inorganic particles. Examples of the inorganic particles include SiO₂ particles, TiO₂ particles, Al₂O₃ particles, CuO particles, ZnO particles, SnO₂ particles, CeO₂ particles, Fe₂O₃ particles, MgO particles, BaO particles, CaO particles, K₂O particles, Na₂O particles, ZrO₂ particles, CaO·SiO₂ particles, K₂O·(TiO₂)ₙ particles, Al₂O₃·2SiO₂ particles, CaCO₃ particles, MgCO₃ particles, BaSO₄ particles, and MgSO₄ particles.

The surfaces of the inorganic particles used as an external additive may be subjected to a hydrophobic treatment. The hydrophobic treatment is performed by, for example, immersing the inorganic particles in a hydrophobizing agent. Examples of the hydrophobizing agent include, but are not limited to, a silane coupling agent, a silicone oil, a titanate coupling agent, and aluminum coupling agent. These hydrophobizing agents may be used alone or in combination of two or more.

The amount of the hydrophobizing agent is commonly, for example, 1 part by mass or more and 10 parts by mass or less relative to 100 parts by mass of the inorganic particles.

Examples of the external additive further include particles of a resin, such as polystyrene, polymethyl methacrylate, or a melamine resin; and particles of a cleaning lubricant, such as a metal salt of a higher fatty acid, such as zinc stearate, or a fluorine-contained resin.

The amount of the external additive used is preferably 0.01% by mass or more and 5% by mass or less and is more preferably 0.01% by mass or more and 2.0% by mass or less of the amount of the toner particles.

### Method for Producing Toner

The fluorescent toner constituting the toner set according to an exemplary embodiment of the disclosure is produced by, after the preparation of the toner particles, depositing an external additive on the surfaces of the toner particles.

The toner particles may be prepared by any dry process, such as knead pulverization, or any wet process, such as aggregation coalescence, suspension polymerization, or dissolution suspension. However, a method for preparing the toner particles is not limited thereto, and any suitable method known in the related art may be used. Among these methods, aggregation coalescence may be used in order to prepare the toner particles.

In the case where toner particles including the aggregation-induced emission colorant are produced by aggregation coalescence, the following production method may be used.

Specifically, a production method including:
a step of preparing a resin particle dispersion liquid in which particles of a resin that serves as a binder resin are dispersed (i.e., resin particle dispersion liquid preparation step);
a step of preparing an aggregation-induced emission colorant dispersion liquid in which particles of the aggregation-induced emission colorant are dispersed (i.e., aggregation-induced emission colorant dispersion liquid preparation step);
a step of mixing the resin particle dispersion liquid with the aggregation-induced emission colorant dispersion liquid and causing the mixed particles to aggregate together in the resulting mixed dispersion liquid to form aggregated particles (i.e., aggregated particle formation step); and
a step of heating the aggregated particle dispersion liquid in which the aggregated particles are dispersed in order to cause fusion and coalescence of the aggregated particles and form toner particles (i.e., fusion-coalescence step).

The above production method may further include a step of preparing a nonfluorescent organic pigment dispersion liquid in which a nonfluorescent pigment is dispersed (i.e., nonfluorescent pigment dispersion liquid preparation step) and a step of preparing a release agent particle dispersion liquid in which release agent particles are dispersed (i.e., release agent particle dispersion liquid preparation step) as needed.

Each of the above steps is described below in detail.

### Resin Particle Dispersion Liquid Preparation Step

The resin particle dispersion liquid is prepared by, for example, dispersing resin particles in a dispersion medium using a surfactant.

Examples of the dispersion medium used for preparing the resin particle dispersion liquid include aqueous media.

Examples of the aqueous media include water, such as distilled water and ion-exchange water; and alcohols. These aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, in particular, the anionic surfactants and the cationic surfactants may be used. The nonionic surfactants may be used in combination with the anionic surfactants and the cationic surfactants.

These surfactants may be used alone or in combination of two or more.

In the preparation of the resin particle dispersion liquid, the resin particles can be dispersed in a dispersion medium by any suitable dispersion method commonly used in the related art in which, for example, a rotary-shearing homogenizer, a ball mill, a sand mill, or a dyno mill that includes media is used. Depending on the type of the resin particles used, the resin particles may be dispersed in the dispersion medium by phase-inversion emulsification. Phase-inversion emulsification is a method in which the resin to be dispersed is dissolved in a hydrophobic organic solvent in which the resin is soluble, a base is added to the resulting organic continuous phase (i.e., O phase) to perform neutralization, and subsequently an aqueous medium (i.e., W phase) is charged in order to perform phase inversion from W/O to O/W and disperse the resin in the aqueous medium in the form of particles.

The volume average size of the resin particles dispersed in the resin particle dispersion liquid is preferably, for example, 0.01 μm or more and 1 μm or less, is more preferably 0.08 μm or more and 0.8 μm or less, and is further preferably 0.1 μm or more and 0.6 μm or less. The volume average size of the resin particles is determined in the following manner. The particle diameter distribution of the resin particles is obtained using a laser-diffraction particle-size-distribution measurement apparatus, such as “LA-700” produced by HORIBA, Ltd. The particle diameter distribution measured is divided into a number of particle diameter ranges (i.e., channels). For each range, in ascending order in terms of particle diameter, the cumulative volume is calculated and plotted to draw a cumulative distribution curve. A particle diameter at which the cumulative volume reaches 50% is considered to be the volume particle diameter D50v. The volume average sizes of particles included in the other dispersion liquids are also determined in the above-described manner.

The content of the resin particles included in the resin particle dispersion liquid is preferably 5% by mass or more and 50% by mass or less and is more preferably 10% by mass or more and 40% by mass or less.

### Release Agent Particle Dispersion Liquid Preparation Step

The method for preparing the release agent particle dispersion liquid is the same as the method for preparing the resin particle dispersion liquid.

The content of the release agent particles in the release agent particle dispersion liquid is preferably 5% by mass or more and 50% by mass or less and is more preferably 10% by mass or more and 40% by mass or less.

### Aggregation-Induced Emission Colorant Dispersion Liquid Preparation Step

The aggregation-induced emission colorant dispersion liquid is prepared by, for example, dispersing the aggregation-induced emission colorant in a dispersion medium with a surfactant.

Examples of the dispersion medium used for the aggregation-induced emission colorant dispersion liquid include an aqueous medium.

Examples of the aqueous medium include water, such as distilled water or ion-exchange water, and an alcohol. The above aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, the anionic and cationic surfactants may be used. The nonionic surfactants may be used in combination with the anionic surfactants and the cationic surfactants.

These surfactants may be used alone or in combination of two or more.

Examples of the method for dispersing the aggregation-induced emission colorant in the dispersion medium include a dispersion method in which a rotary-shearing homogenizer, a ball mill, a sand mill, a dyno mill, or Key Mill that includes media, or the like is used.

The volume average size of particles of the aggregation-induced emission colorant dispersed in the aggregation-induced emission colorant dispersion liquid is, for example, preferably 100 nm or more and 1,000 nm or less, is more preferably 150 nm or more and 500 nm or less, and is further preferably 200 nm or more and 400 nm or less. The size of particles of the aggregation-induced emission colorant can be adjusted by changing, for example, the method of the dispersion treatment and the amount of time during which the dispersion treatment is performed.

The content of the aggregation-induced emission colorant in the aggregation-induced emission colorant dispersion liquid is preferably 5% by mass or more and 50% by mass or less and is more preferably 10% by mass or more and 40% by mass or less.

### Nonfluorescent Pigment Dispersion Liquid Preparation Step

The nonfluorescent pigment dispersion liquid is prepared by, for example, dispersing a nonfluorescent organic pigment in a dispersion medium with a surfactant.

Examples of the dispersion medium used for the nonfluorescent pigment dispersion liquid include an aqueous medium.

Examples of the aqueous medium include water, such as distilled water or ion-exchange water, and an alcohol. The above aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, the anionic and cationic surfactants may be used. The nonionic surfactants may be used in combination with the anionic surfactants and the cationic surfactants.

These surfactants may be used alone or in combination of two or more.

Examples of the method for dispersing the nonfluorescent pigment in the dispersion medium include a dispersion method in which a rotary-shearing homogenizer, a ball mill, a sand mill, a dyno mill, or Key Mill that includes media, or the like is used.

The volume average size of particles of the nonfluorescent pigment dispersed in the nonfluorescent pigment dispersion liquid is, for example, preferably 50 nm or more and 300 nm or less, is more preferably 100 nm or more and 250 nm or less, and is further preferably 120 nm or more and 200 nm or less. The size of particles of the nonfluorescent pigment can be adjusted by changing, for example, the method of the dispersion treatment and the amount of time during which the dispersion treatment is performed.

The content of the nonfluorescent pigment in the nonfluorescent pigment dispersion liquid is preferably 5% by mass or more and 50% by mass or less and is more preferably 10% by mass or more and 40% by mass or less.

### Aggregated Particle Formation Step

The resin particle dispersion liquid is mixed with the aggregation-induced emission colorant dispersion liquid and, as needed, the nonfluorescent organic pigment dispersion liquid and the release agent particle dispersion liquid. In the resulting mixed dispersion liquid, heteroaggregation of the resin particles, the aggregation-induced emission colorant, and, as needed, the nonfluorescent pigment and the release agent particles is performed to form aggregated particles that have a diameter close to that of the intended toner particles.

Specifically, for example, a coagulant is added to the mixed dispersion liquid, and the pH of the mixed dispersion liquid is controlled to be acidic (e.g., pH of 2 or more and 5 or less). A dispersion stabilizer may be added to the mixed dispersion liquid as needed. Subsequently, the mixed dispersion liquid is heated to a temperature close to the glass transition temperature of the resin particles (specifically, e.g., [Glass transition temperature of the resin particles−30° C.] or more and [the Glass transition temperature−10° C.] or less), and thereby the particles dispersed in the mixed dispersion liquid are caused to aggregate together to form aggregated particles.

In the aggregated particle formation step, alternatively, for example, the above coagulant may be added to the mixed dispersion liquid at room temperature (e.g., 25° C.) while the mixed dispersion liquid is stirred using a rotary-shearing homogenizer. Then, the pH of the mixed dispersion liquid is controlled to be acidic (e.g., pH of 2 or more and 5 or less), and a dispersion stabilizer may be added to the mixed dispersion liquid as needed. Subsequently, the mixed dispersion liquid is heated in the above-described manner.

Examples of the coagulant include surfactants, inorganic metal salts, and divalent or higher metal complexes that have a polarity opposite to that of the surfactant included in the mixed dispersion liquid. Using a metal complex as a coagulant reduces the amount of surfactant used and, as a result, charging characteristics may be enhanced.

An additive capable of forming a complex or a bond similar to a complex with the metal ions contained in the coagulant may optionally be used in combination with the coagulant. An example of the additive is a chelating agent.

Examples of the inorganic metal salts include metal salts, such as calcium chloride, calcium nitrate, barium chloride, magnesium chloride, zinc chloride, aluminum chloride, and aluminum sulfate; and inorganic metal salt polymers, such as polyaluminum chloride, polyaluminum hydroxide, and calcium polysulfide.

The chelating agent may be a water-soluble chelating agent. Examples of such a chelating agent include oxycarboxylic acids, such as tartaric acid, citric acid, and gluconic acid; and aminocarboxylic acids, such as iminodiacetic acid (IDA), nitrilotriacetic acid (NTA), and ethylenediaminetetraacetic acid (EDTA).

The amount of the chelating agent used is preferably 0.01 parts by mass or more and 5.0 parts by mass or less and is more preferably 0.1 parts by mass or more and less than 3.0 parts by mass relative to 100 parts by mass of the resin particles.

### Fusion Coalescence Step

The aggregated particle dispersion liquid in which the aggregated particles are dispersed is heated to, for example, a temperature equal to or higher than the glass transition temperature of the resin particles (e.g., [Glass transition temperature of the resin particles+10° C.] or more and [the Glass transition temperature+30° C.] or less) in order to perform fusion and coalescence of the aggregated particles and form toner particles.

The toner particles are produced through the above-described steps.

The toner particles may be produced by, subsequent to the preparation of the aggregated particle dispersion liquid in which the aggregated particles are dispersed, mixing the aggregated particle dispersion liquid with a resin particle dispersion liquid in which resin particles are dispersed and causing aggregation such that the resin particles are adhered onto the surfaces of the aggregated particles to form second aggregated particles; and heating a second aggregated particle dispersion liquid in which the second aggregated particles are dispersed to cause fusion and coalescence of the second aggregated particles and form toner particles having a core-shell structure.

After the completion of the fusion-coalescence step, the toner particles included in the dispersion liquid are subjected to any suitable cleaning step, solid-liquid separation step, and drying step that are known in the related art in order to obtain dried toner particles. In the cleaning step, the toner particles may be subjected to displacement washing using ion-exchange water to a sufficient degree from the viewpoint of electrification characteristics. Examples of a solid-liquid separation method used in the solid-liquid separation step include suction filtration and pressure filtration from the viewpoint of productivity. Examples of a drying method used in the drying step include freeze-drying, flash drying, fluidized drying, and vibrating fluidized drying from the viewpoint of productivity.

In the case where toner particles that include a fluorescent dye are produced by aggregation coalescence, a production method that is the same as the above-described method for producing toner particles including an aggregation-induced emission colorant by aggregation coalescence, except that the step of preparing an aggregation-induced emission colorant dispersion liquid in which an aggregation-induced emission colorant is dispersed (i.e., an aggregation-induced emission colorant dispersion liquid preparation step) is replaced with a step of preparing a dispersion liquid in which particles colored with a fluorescent dye are dispersed (i.e., a fluorescent dye-colored particle dispersion liquid preparation step), may be used

### Fluorescent Dye-Colored Particle Dispersion Liquid Preparation Step

The fluorescent dye-colored particle dispersion liquid is prepared by, for example, mixing a fluorescent dye with a resin while heating is performed, pulverizing the resulting mixture to form colored particles, and dispersing the colored particles in a dispersion medium with a surfactant.

The resin mixed with the fluorescent dye while heated is a resin that serves as a binder resin.

In the case where a pigmented fluorescent dye is used as a fluorescent dye, the fluorescent dye-colored particle dispersion liquid may be prepared by dispersing a pigmented fluorescent dye in a dispersion medium with a surfactant.

For pulverizing the above mixture, pulverizing machines known in the related art, such as Banbury mixer or a jet mill, may be used. A plurality of pulverizing machines may be used in combination.

Examples of the dispersion medium used for the fluorescent dye-colored particle dispersion liquid include an aqueous medium.

Examples of the aqueous medium include water, such as distilled water or ion-exchange water, and an alcohol. The above aqueous media may be used alone or in combination of two or more.

Examples of the surfactant include anionic surfactants, such as sulfate surfactants, sulfonate surfactants, and phosphate surfactants; cationic surfactants, such as amine salt surfactants and quaternary ammonium salt surfactants; and nonionic surfactants, such as polyethylene glycol surfactants, alkylphenol ethylene oxide adduct surfactants, and polyhydric alcohol surfactants. Among these surfactants, the anionic and cationic surfactants may be used. The nonionic surfactants may be used in combination with the anionic surfactants and the cationic surfactants.

These surfactants may be used alone or in combination of two or more.

Examples of the method for dispersing the fluorescent dye-colored particles in the dispersion medium include a dispersion method in which a rotary-shearing homogenizer, a ball mill, a sand mill, a dyno mill, or Key Mill that includes media, or the like is used.

The volume average size of the fluorescent colored particles included in the fluorescent dye-colored particle dispersion liquid is preferably, for example, 50 nm or more and 300 nm or less and is more preferably 100 nm or more and 250 nm or less. The size of the dye-colored particles can be adjusted by changing, for example, the method of the dispersion treatment and the amount of time during which the dispersion treatment is performed.

The content of the dye-colored particles included in the fluorescent dye-colored particle dispersion liquid is preferably 5% by mass or more and 50% by mass or less and is more preferably 10% by mass or more and 40% by mass or less.

The fluorescent toner is produced by, for example, adding an external additive to the dried toner particles and mixing the resulting toner particles using a V-blender, a HENSCHEL mixer, a Lodige mixer, or the like. Optionally, coarse toner particles may be removed using a vibrating screen classifier, a wind screen classifier, or the like.

### Electrostatic Image Developer Set

An electrostatic image developer set according to an exemplary embodiment of the disclosure includes a first electrostatic image developer including one of the fluorescent toners included in the toner set according to an exemplary embodiment of the disclosure and a second electrostatic image developer including the other of the fluorescent toners included in the toner set according to an exemplary embodiment of the disclosure.

Each of the electrostatic image developers may be a single component developer including a fluorescent toner or may be a two-component developer that is a mixture of a fluorescent toner and a carrier.

The type of the carrier is not limited, and any suitable carrier known in the related art may be used. Examples of the carrier include a coated carrier prepared by coating the surfaces of cores including magnetic powder particles with a resin; a magnetic-powder-dispersed carrier prepared by dispersing and mixing magnetic powder particles in a matrix resin; and a resin-impregnated carrier prepared by impregnating a porous magnetic powder with a resin.

The magnetic-powder-dispersed carrier and the resin-impregnated carrier may also be prepared by coating the surfaces of particles constituting the carrier, that is, core particles, with a resin.

Examples of the magnetic powder include powders of magnetic metals, such as iron, nickel, and cobalt; and powders of magnetic oxides, such as ferrite and magnetite.

Examples of the coat resin and the matrix resin include polyethylene, polypropylene, polystyrene, poly(vinyl acetate), poly(vinyl alcohol), poly(vinyl butyral), poly(vinyl chloride), poly(vinyl ether), poly(vinyl ketone), a vinyl chloride-vinyl acetate copolymer, a styrene-acrylic acid ester copolymer, a straight silicone resin including an organosiloxane bond and the modified products thereof, a fluorine resin, polyester, polycarbonate, a phenolic resin, and an epoxy resin. The coat resin and the matrix resin may optionally include additives, such as conductive particles. Examples of the conductive particles include particles of metals, such as gold, silver, and copper; and particles of carbon black, titanium oxide, zinc oxide, tin oxide, barium sulfate, aluminum borate, and potassium titanate.

The surfaces of the cores can be coated with a resin by, for example, using a coating-layer forming solution prepared by dissolving the coat resin and various types of additives (used as needed) in a suitable solvent. The type of the solvent is not limited and may be selected with consideration of the type of the resin used, case of applying the coating-layer forming solution, and the like.

Specific examples of a method for coating the surfaces of the cores with the coat resin include an immersion method in which the cores are immersed in the coating-layer forming solution; a spray method in which the coating-layer forming solution is sprayed onto the surfaces of the cores; a fluidized-bed method in which the coating-layer forming solution is sprayed onto the surfaces of the cores while the cores are floated using flowing air; and a kneader-coater method in which the cores of the carrier are mixed with the coating-layer forming solution in a kneader coater and subsequently the solvent is removed.

The mixing ratio (i.e., mass ratio) of the fluorescent toner to the carrier in the two-component developer is preferably Fluorescent toner: Carrier=1:100 to 30:100 and is more preferably 3:100 to 20:100.

### Image Forming Apparatus and Image Forming Method

An image forming apparatus and image forming method according to an exemplary embodiment of the disclosure are described below.

An image forming apparatus according to an exemplary embodiment of the disclosure includes a first image formation unit that forms a first fluorescent image with one of the two colors of fluorescent toners included in the toner set according to an exemplary embodiment of the disclosure; a second image formation unit that forms a second fluorescent image with another of the two colors of fluorescent toners included in the toner set according to an exemplary embodiment of the disclosure; a transfer unit that transfers the first and second fluorescent images to a recording medium; and a fixing unit that fixes the first and second fluorescent images to the recording medium.

The image forming apparatus according to an exemplary embodiment of the disclosure may include first and second image formation units that each include an image holding member, a charging unit that charges the surface of the image holding member, an electrostatic image formation unit that forms an electrostatic image on the charged surface of the image holding member, and a developing unit that develops the electrostatic image formed on the surface of the image holding member with an electrostatic image developer to form a toner image.

Alternatively, the image forming apparatus according to an exemplary embodiment of the disclosure may include an image holding member, a charging unit that charges the surface of the image holding member, an electrostatic image formation unit that forms an electrostatic image on the charged surface of the image holding member, and first and second image formation units that include first and second developing units, respectively, which develop the electrostatic image formed on the surface of the image holding member with an electrostatic image developer to form a toner image.

The image forming apparatus according to an exemplary embodiment of the disclosure executes an image forming method (i.e., an image forming method according to an exemplary embodiment of the disclosure) including a first image formation step of forming a first fluorescent image with one of the two colors of fluorescent toners included in the toner set according to an exemplary embodiment of the disclosure, a second image formation step of forming a second fluorescent image with another of the two colors of fluorescent toners included in the toner set according to an exemplary embodiment of the disclosure, a transfer step of transferring the first and second fluorescent images to a recording medium, and a fixing step of fixing the first and second fluorescent images to the recording medium.

The image forming apparatus according to an exemplary embodiment of the disclosure may be any image forming apparatus known in the related art, such as a direct-transfer image forming apparatus in which a toner image formed on the surface of an image holding member is directly transferred to a recording medium; an intermediate-transfer image forming apparatus in which a toner image formed on the surface of an image holding member is transferred onto the surface of an intermediate transfer body in the first transfer step and the toner image transferred on the surface of the intermediate transfer body is transferred onto the surface of a recording medium in the second transfer step; an image forming apparatus including a cleaning unit that cleans the surface of the image holding member subsequent to the transfer of the toner image before the image holding member is again charged; and an image forming apparatus including a static-erasing unit that erases static by irradiating the surface of an image holding member with static-erasing light subsequent to the transfer of the toner image before the image holding member is again charged.

In the case where the image forming apparatus according to this exemplary embodiment is the intermediate-transfer image forming apparatus, the transfer unit may be constituted by, for example, an intermediate transfer body to which a toner image is transferred, a first transfer subunit that transfers a toner image formed on the surface of the image holding member onto the surface of the intermediate transfer body in the first transfer step, and a second transfer subunit that transfers the toner image transferred on the surface of the intermediate transfer body onto the surface of a recording medium in the second transfer step.

An example of the image forming apparatus according to an exemplary embodiment of the disclosure is described below, but the image forming apparatus is not limited thereto. Hereinafter, only components illustrated in drawings are described; others are omitted.

A sextuple tandem image forming apparatus that includes six image forming units arranged in series is described below as an example of the image forming apparatus according to an exemplary embodiment of the disclosure. Note that the tandem image forming apparatus is not limited to this; the image forming apparatus according to this exemplary embodiment may be a quintuple tandem image forming apparatus that includes five image forming units arranged in series or a quadruple tandem image forming apparatus that includes four image forming units arranged in series.

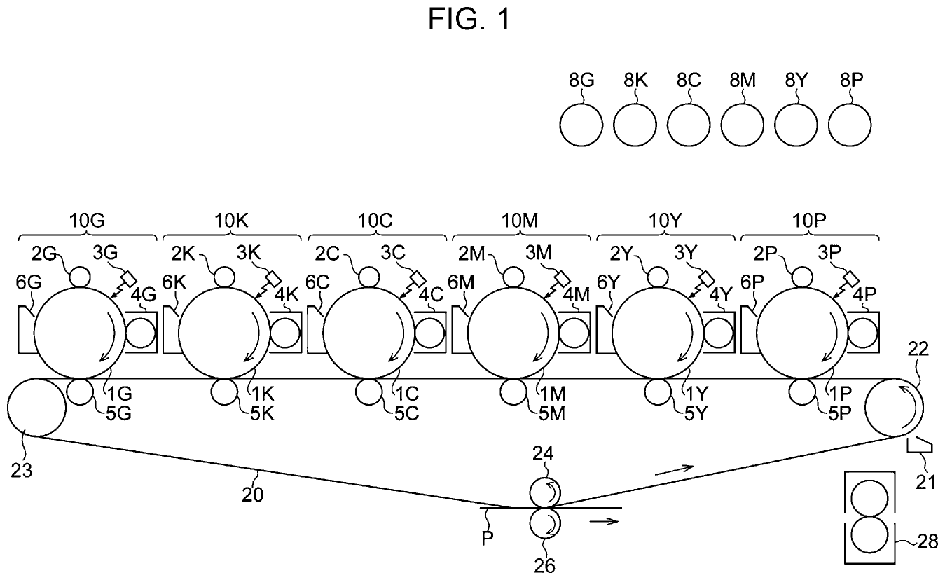

FIG. 1 schematically illustrates the image forming apparatus according to an exemplary embodiment of the disclosure. FIG. 1 illustrates a sextuple tandem, intermediate transfer-type image forming apparatus

The image forming apparatus illustrated in FIG. 1 includes first to sixth image formation units 10P, 10Y, 10M, 10C, 10K, and 10G, which are electrophotographic image forming units that form pink (P), yellow (Y), magenta (M), cyan (C), black (K), and green (G) images, respectively, on the basis of color separation image data. The image formation units (hereinafter, referred to simply as “units”) 10P, 10Y, 10M, 10C, 10K, and 10G are horizontally arranged in parallel at a predetermined distance from one another. The units 10P, 10Y, 10M, 10C, 10K, and 10G may be process cartridges detachably attachable to the image forming apparatus.

Although the image forming apparatus illustrated in FIG. 1 includes pink (P) and green (G) image formation units, the structure of the image forming apparatus is not limited to this.

An intermediate transfer belt (an example of the intermediate transfer body) 20 runs below and extends over the units 10P, 10Y, 10M, 10C, 10K, and 10G so as to pass through the units. The intermediate transfer belt 20 is wound around a drive roller 22, a support roller 23, and a counter roller 24 arranged to contact with the inner surface of the intermediate transfer belt 20 and runs in the direction from the first unit 10P to the sixth unit 10G. An intermediate transfer body-cleaning device 21 is disposed so as to contact with the image holding member-side surface of the intermediate transfer belt 20 and to face the drive roller 22.

Developing devices (i.e., examples of developing units) 4P, 4Y, 4M, 4C, 4K, and 4G of the units 10P, 10Y, 10M, 10C, 10K, and 10G are supplied with pink, yellow, magenta, cyan, black, and green toners stored in toner cartridges 8P, 8Y, 8M, 8C, 8K, and 8G, respectively.

Since the first to sixth units 10P, 10Y, 10M, 10C, 10K, and 10G have the same structure and the same action, the following description is made with reference to, as a representative, the sixth unit 10G that forms a green image.

The sixth unit 10G includes a photosensitive member 1G serving as an image holding member. The following components are disposed around the photosensitive member 1G sequentially in the counterclockwise direction: a charging roller (example of the charging unit) 2G that charges the surface of the photosensitive member 1G at a predetermined potential; an exposure device (example of the electrostatic image formation unit) 3G that forms an electrostatic image by irradiating the charged surface of the photosensitive member 1G with a laser beam based on a color separated image signal; a developing device (example of the developing unit) 4G that develops the electrostatic image by supplying a toner to the electrostatic image; a first transfer roller (example of the first transfer subunit) 5G that transfers the developed toner image to the intermediate transfer belt 20; and a photosensitive-member cleaning device (example of the cleaning unit) 6G that removes a toner remaining on the surface of the photosensitive member 1G after the first transfer.

The first transfer roller 5G is disposed so as to contact with the inner surface of the intermediate transfer belt 20 and to face the photosensitive member 1G. Each of the first transfer rollers 5Y, 5P, 5M, 5C, 5G, and 5K of the respective units is connected to a bias power supply (not illustrated) that applies a first transfer bias to the first transfer rollers. Each bias power supply varies the transfer bias applied to the corresponding first transfer roller on the basis of the control by a controller (not illustrated).

The action of forming a green image in the sixth unit 10G is described below.

Before the action starts, the surface of the photosensitive member 1G is charged at a potential of −600 to −800 V by the charging roller 2G.

The photosensitive member 1G is formed by stacking a photosensitive layer on a conductive substrate (e.g., volume resistivity at 20° C.: 1×10⁻⁶ Ωcm or less). The photosensitive layer is normally of high resistance (comparable with the resistance of ordinary resins), but, upon being irradiated with the laser beam, the specific resistance of the portion irradiated with the laser beam varies. Thus, the exposure device 3G irradiates the surface of the charged photosensitive member 1G with the laser beam on the basis of the image data of the green image sent from the controller (not illustrated). As a result, an electrostatic image of green image pattern is formed on the surface of the photosensitive member 1G.

The term “electrostatic image” used herein refers to an image formed on the surface of the photosensitive member 1G by charging, the image being a “negative latent image” formed by irradiating a portion of the photosensitive layer with a laser beam emitted by the exposure device 3G to reduce the specific resistance of the irradiated portion such that the charges on the irradiated surface of the photosensitive member 1G discharge while the charges on the portion that is not irradiated with the laser beam remain.

The electrostatic image, which is formed on the photosensitive member 1G as described above, is sent to the predetermined developing position by the rotating photosensitive member 1G. The electrostatic image on the photosensitive member 1G is developed and visualized in the form of a toner image by the developing device 4G at the developing position.

The developing device 4G includes an electrostatic image developer including, for example, at least, a green toner and a carrier. The green toner is stirred in the developing device 4G to be charged by friction and supported on a developer roller (example of the developer support), carrying an electric charge of the same polarity (i.e., negative) as the electric charge generated on the photosensitive member 1G. The green toner is electrostatically adhered to the erased latent image portion on the surface of the photosensitive member 1G as the surface of the photosensitive member 1G passes through the developing device 4G. Thus, the latent image is developed using the green toner. The photosensitive member 1G on which the green toner image is formed keeps rotating at the predetermined rate, thereby transporting the toner image developed on the photosensitive member 1G to the predetermined first transfer position.

Upon the green toner image on the photosensitive member 1G reaching the first transfer position, first transfer bias is applied to the first transfer roller 5G so as to generate an electrostatic force on the toner image in the direction from the photosensitive member 1G toward the first transfer roller 5G. Thus, the toner image on the photosensitive member 1G is transferred to the intermediate transfer belt 20. The transfer bias applied has the opposite polarity (+) to that of the toner (−) and controlled to be, for example, in the sixth unit 10G, +10 μA by a controller (not illustrated).

After the toner image has been transferred from the photosensitive member 1G to the intermediate transfer belt 20, the photosensitive member 1G keeps rotating and is brought into contact with a cleaning blade included in the photosensitive member cleaning device 6G. The toner particles remaining on the photosensitive member 1G are removed by the photosensitive-member cleaning device 6G and then collected.

The intermediate transfer belt 20 is successively transported through the first to sixth image forming units 10P, 10Y, 10M, 10C, 10K, and 10G while toner images of the respective colors are stacked on top of another.

The resulting intermediate transfer belt 20 on which toner images of six colors are multiple-transferred in the first to sixth units is then transported to a second transfer section including a counter roller 24 contacting with the inner surface of the intermediate transfer belt 20 and a second transfer roller (example of the second transfer subunit) 26 disposed on the image-carrier-side of the intermediate transfer belt 20. A recording paper (example of the recording medium) P is fed by a feed mechanism into a narrow space between the second transfer roller 26 and the intermediate transfer belt 20 that contact with each other at the predetermined timing. The second transfer bias is then applied to the counter roller 24. The transfer bias applied here has the same polarity (−) as that of the toner (−) and generates an electrostatic force on the toner image in the direction from the intermediate transfer belt 20 toward the recording paper P. Thus, the toner image on the intermediate transfer belt 20 is transferred to the recording paper P. The intensity of the second transfer bias applied is determined on the basis of the resistance of the second transfer section which is detected by a resistance detector (not illustrated) that detects the resistance of the second transfer section and controlled by changing voltage.

After the toner image has been transferred from the intermediate transfer belt 20 to the recording paper P, the intermediate transfer belt 20 keeps running and is brought into contact with a cleaning blade included in the intermediate transfer body cleaning device 21. The toner particles remaining on the intermediate transfer belt 20 are removed by the intermediate transfer body cleaning device 21 and then collected.

The recording paper P on which the toner image is transferred is transported into a nip part of the fixing device (example of the fixing unit) 28 at which a pair of fixing rollers contact with each other. The toner image is fixed to the recording paper P to form a fixed image.

Examples of the recording paper P to which a toner image is transferred include plain paper used in electrophotographic copiers, printers, and the like. Instead of the recording paper P, OHP films and the like may be used as a recording medium.

The surface of the recording paper P may be smooth in order to enhance the smoothness of the surface of the fixed image. Examples of such a recording paper include coated paper produced by coating the surface of plain paper with resin or the like and art paper for printing.

The recording paper P, to which the color image has been fixed, is transported toward an exit portion. Thus, the series of the steps for forming a color image are terminated.

### Process Cartridge and Toner Cartridge Set

A process cartridge according to an exemplary embodiment of the disclosure is described below.

The process cartridge according to an exemplary embodiment of the disclosure is a process cartridge detachably attachable to an image forming apparatus, the process cartridge including a first developing unit including the first electrostatic image developer included in the electrostatic image developer set according to an exemplary embodiment of the disclosure and a second developing unit including the second electrostatic image developer included in the electrostatic image developer set according to an exemplary embodiment of the disclosure.

The structure of the process cartridge according to an exemplary embodiment of the disclosure is not limited to the above-described one. The process cartridge may further include, in addition to the developing device, at least one unit selected from an image holding member, a charging unit, an electrostatic image formation unit, a transfer unit, etc.

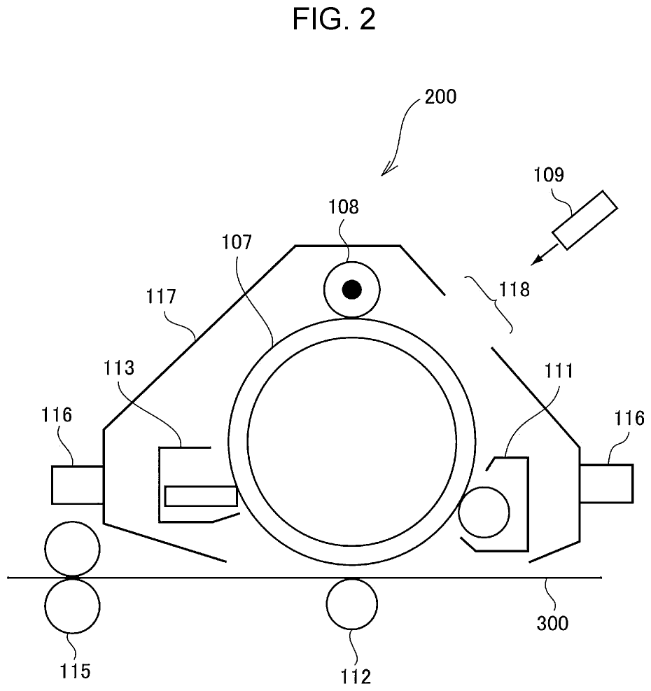

An example of the process cartridge according to an exemplary embodiment of the disclosure is described below, but the process cartridge is not limited thereto. Hereinafter, only components illustrated in FIG. 2 are described; others are omitted.

FIG. 2 schematically illustrates the process cartridge according to an exemplary embodiment of the disclosure.

A process cartridge 200 illustrated in FIG. 2 includes, for example, a photosensitive member 107 (example of the image holding member), a charging roller 108 (example of the charging unit) disposed on the periphery of the photosensitive member 107, a developing device 111 (example of the developing unit), and a photosensitive-member cleaning device 113 (example of the cleaning unit), which are combined into one unit using a housing 117 to form a cartridge. The housing 117 has an aperture 118 for exposure. A mounting rail 116 is disposed on the housing 117.

In FIG. 2, Reference numeral 109 denotes an exposure device (example of the electrostatic image formation unit), Reference numeral 112 denotes a transfer device (example of the transfer unit), Reference numeral 115 denotes a fixing device (example of the fixing unit), and the Reference numeral 300 denotes recording paper (example of the recording medium).

A toner cartridge set according to an exemplary embodiment of the disclosure is described below.

The toner cartridge set according to an exemplary embodiment of the disclosure is a toner cartridge set detachably attachable to an image forming apparatus, the toner cartridge set including a first toner cartridge including one of the two colors of fluorescent toners included in the toner set according to an exemplary embodiment of the disclosure and a second toner cartridge including another of the two colors of fluorescent toners included in the toner set according to an exemplary embodiment of the disclosure.

The toner cartridges each include a replenishment toner that is to be supplied to the developing unit disposed inside an image forming apparatus.

The image forming apparatus illustrated in FIG. 1 is an image forming apparatus that includes the toner cartridges 8Y, 8P, 8M, 8C, 8G, and 8K detachably attached to the image forming apparatus. Each of the developing devices 4Y, 4P, 4M, 4C, 4G, and 4K is connected to a specific one of the toner cartridges which corresponds to the color of the developing device with a toner supply pipe (not illustrated). When the amount of toner contained in a toner cartridge is small, the toner cartridge is replaced. The toner cartridge 8G is an example of the toner cartridge according to an exemplary embodiment of the disclosure and includes the toner set according to an exemplary embodiment of the disclosure. The toner cartridges 8P, 8Y, 8M, 8C, and 8K include pink, yellow, magenta, cyan, and black toners, respectively.

### Printed Material

A printed material according to an exemplary embodiment of the disclosure includes a recording medium, a first fluorescent image including one of the two colors of fluorescent toners included in the toner set according to an exemplary embodiment of the disclosure, and a second fluorescent image including another of the two colors of fluorescent toners included in the toner set according to an exemplary embodiment of the disclosure, the second fluorescent image being arranged to overlap at least a portion of the first fluorescent image.

The printed material according to an exemplary embodiment of the disclosure is produced using the above-described image forming apparatus or method according to an exemplary embodiment of the disclosure.

The printed material according to an exemplary embodiment of the disclosure includes at least a recording medium and the first and second fluorescent images formed on the surface of the recording medium and may further include an image formed using a toner having a color other than that of the first or second fluorescent image, such as yellow, magenta, cyan, or black.

As described above, the recording medium included in the printed material according to an exemplary embodiment of the disclosure may be a recording paper sheet P, an OHP film, or the like.

### Examples

Details of the exemplary embodiments of the present disclosure are described with reference to Examples below. It should be noted that the exemplary embodiments of the present disclosure are not limited by Examples.

Hereinafter, all “part” and “%” are on a mass basis unless otherwise specified.

Synthesis, treatment, production, and the like are conducted at room temperature (25° C.±3° C.) unless otherwise specified.

### Preparation of Fluorescent Toner G1 and Fluorescent Developer G1

### Preparation of Aggregation-Induced Emission Colorant Dispersion Liquid (1)

Aggregation-induced emission colorant (C. I. Pigment Yellow 101 “Radglo VSF-0-01” produced by Radiant Color, emission peak wavelength: 520 nm): 70 parts
Anionic surfactant “Neogen RK” produced by Dai-ichi Kogyo Seiyaku Co., Ltd.: 30 parts (solid component concentration: 20%)
Ion-exchange water: 200 parts

The above components are mixed together, and the resulting mixture is pulverized to 250 nm with Key Mill (continuous type) “KMC-3”. The solid content in the resulting dispersion liquid is adjusted to 20% by mass. Hereby, an aggregation-induced emission colorant dispersion liquid (1) is prepared.

### Preparation of Resin Particle Dispersion Liquid (1)

Terephthalic acid: 30 molar parts
Fumaric acid: 70 molar parts
Bisphenol A-ethylene oxide adduct: 5 molar parts
Bisphenol A-propylene oxide adduct: 95 molar parts

The above materials are charged into a flask equipped with a stirrer, a nitrogen introduction tube, a temperature sensor, and a fractionating column. After the temperature of the resulting mixture has been increased to 220° C. over 1 hour, 1 part of titanium tetraethoxide relative to 100 parts of the materials is charged into the flask. While the product water is distilled away, the temperature is increased to 230° C. over 30 minutes. After the dehydration condensation reaction has been continued for 1 hour at the above temperature, the reaction product is cooled. Hereby, a polyester resin having a weight average molecular weight of 18,000 and a glass transition temperature of 60° C. is prepared.

Into a container equipped with a temperature control unit and a nitrogen purge unit, 40 parts of ethyl acetate and 25 parts of 2-butanol are charged in order to prepare a mixed solvent. To the mixed solvent, 100 parts of the polyester resin is gradually added in order to form a solution. To the solution, a 10-mass % aqueous ammonia solution is added in an amount that corresponds to three times the acid value of the resin in terms of molar ratio, and the resulting mixture is stirred for 30 minutes. Subsequently, the inside of the container is purged with dry nitrogen. While the temperature is kept at 40° C. and the liquid mixture is stirred, 400 parts of ion-exchange water is added dropwise to the container at a rate of 2 part/min. After the addition of ion-exchange water has been finished, the temperature is reduced to room temperature (20° C. to 25° C.). Subsequently, while stirring is performed, bubbling is performed for 48 hours using dry nitrogen in order to reduce the concentration of ethyl acetate and 2-butanol in the resulting resin particle dispersion liquid to 1,000 ppm or less. Then, ion-exchange water is added to the resin particle dispersion liquid in order to adjust the solid content in the resin particle dispersion liquid to 20% by mass. Hereby, a resin particle dispersion liquid (1) is prepared.

### Preparation of Release Agent Particle Dispersion Liquid (1)

Paraffin wax “HNP-9” produced by Nippon Seiro Co., Ltd.: 100 parts
Anionic surfactant “Neogen RK” produced by Dai-ichi Kogyo Seiyaku Co., Ltd.: 1 part
Ion-exchange water: 350 parts

The above materials are mixed together, and the resulting mixture is heated to 100° C. and dispersed with a homogenizer “ULTRA-TURRAX T50” produced by IKA. Subsequently, further dispersion treatment is performed with a Manton-Gaulin high pressure homogenizer produced by Gaulin. Hereby, a release agent particle dispersion liquid (1) (solid content: 20% by mass), in which release agent particles having a volume average size of 200 nm are dispersed, is prepared.

### Preparation of Toner Particles (1)

Resin particle dispersion liquid (1): 400 parts
Aggregation-induced emission colorant dispersion liquid (1): 50 parts
Release agent particle dispersion liquid (1): 25 parts
Anionic surfactant “Neogen RK” Dai-ichi Kogyo Seiyaku Co., Ltd. (20%): 10 parts

The above materials are charged into a round-bottomed, stainless steel flask. After the pH has been adjusted to 3.5 by the addition of 0.1 N (mol/L) nitric acid, 30 parts of an aqueous nitric acid solution having a polyaluminum chloride concentration of 10% by mass is added to the flask. The resulting mixture is dispersed with a homogenizer “ULTRA-TURRAX T50” produced by IKA at a liquid temperature of 30° C. and subsequently heated to 45° C. in an oil bath for heating. Then, holding is performed for 30 minutes. Subsequently, 50 parts of the resin particle dispersion liquid (1) is added to the flask, and holding is performed for 1 hour. To the flask, a 0.1-N aqueous sodium hydroxide solution is added in order to adjust the pH to 8.5. Subsequently, the temperature is increased to 84° C. and holding is performed for 2.5 hours. Then, the temperature is reduced to 20° C. at 20° C./min, and the solid component is separated from the liquid by filtering, washed thoroughly with ion-exchange water, and dried. Hereby, toner particles (1) are prepared. The volume average size of the toner particles (1) is 5.8 μm.

### Preparation of Carrier 1

Ferrite particles (average size: 35 μm): 100 parts
Toluene: 14 parts
Polymethyl methacrylate (MMA, weight average molecular weight: 75,000): 5 parts
Carbon black “VXC-72” produced by Cabot Corporation (volume resistivity: 100 Ωcm or less): 0.2 parts

The above materials except the ferrite particles are dispersed with a sand mill to form a dispersion liquid. The dispersion liquid and the ferrite particles are charged into a degassing vacuum kneader. Then, while stirring is performed, the pressure is reduced and drying is performed. Hereby, a carrier 1 is prepared.

### Preparation of Toner

With 100 parts by mass of the toner particles (1), 1.5 parts by mass of hydrophobic silica “RY50” produced by Nippon Aerosil Co., Ltd. and 1.0 parts by mass of hydrophobic titanium oxide “T805” produced by Nippon Aerosil Co., Ltd. are mixed using a sample mill at 10,000 revolutions per minute (rpm) for 30 seconds. Subsequently, sieving is performed with a vibration sieve having an opening of 45 μm. Hereby, a fluorescent toner G1 is prepared. The volume average particle size of the fluorescent toner G1 is 5.8 μm.

### Preparation of Electrostatic Image Developer

A fluorescent developer 1 (i.e., electrostatic image developer) is prepared by mixing 8 parts of the fluorescent toner G1 with 92 parts of the carrier 1 using a V-blender.

### Preparation of Fluorescent Toners G2 to G18 and Fluorescent Developers G2 to G18

Fluorescent toners G2 to G18 are prepared as in the preparation of the fluorescent toner G1, except that the type of the fluorescent colorant (i.e., the aggregation-induced emission colorant) used, the size of particles of the fluorescent colorant, the content of the fluorescent colorant, the use of a nonfluorescent colorant, and the type and content of the nonfluorescent colorant are changed as described in Table 1 and the molecular weight of the polyester resin included in the resin particle dispersion liquid is changed as needed. Developers G2 to G18 are prepared as in the preparation of the developer G1, except that the fluorescent toners G2 to G18 are used, respectively.

Note that the size of particles of the aggregation-induced emission colorant can be adjusted by changing the amount of time during which a dispersion treatment is performed in the preparation of the aggregation-induced emission colorant dispersion liquid.

In the preparation of the fluorescent toner G2, the nonfluorescent pigment dispersion liquid (1) described below is used. In the preparation of the fluorescent toner G3, a nonfluorescent pigment dispersion liquid (2) prepared as in the preparation of the nonfluorescent pigment dispersion liquid (1) except that the nonfluorescent green pigment included in the nonfluorescent pigment dispersion liquid (1) is changed to “PG7” (C. I. Pigment Green 7 “LIONOL GREEN 8390” produced by Toyocolor Co., Ltd.) is used. In the preparation of the fluorescent toner G4, a nonfluorescent pigment dispersion liquid (3) prepared as in the preparation of the nonfluorescent pigment dispersion liquid (1) except that the nonfluorescent green pigment included in the nonfluorescent pigment dispersion liquid (1) is changed to “PB15: 3” (C. I. Pigment Blue 15:3 “LIONOL BLUE FG-7330” produced by Toyocolor Co., Ltd.) is used. In the preparation of the fluorescent toner G16, a nonfluorescent pigment dispersion liquid (4) prepared as in the preparation of the nonfluorescent pigment dispersion liquid (1) except that the nonfluorescent green pigment included in the nonfluorescent pigment dispersion liquid (1) is changed to “PO38” (C. I. Pigment Orange 38 “Graphtol Red HFG” produced by Clariant) is used.

### Preparation of Nonfluorescent Pigment Dispersion Liquid (1)

Nonfluorescent Green Pigment (C. I. Pigment Green 36 “LIONOL GREEN 8624” produced by Toyocolor Co., Ltd.): 70 parts
Anionic surfactant “Neogen RK” produced by Dai-ichi Kogyo Seiyaku Co., Ltd.: 30 parts (solid component concentration: 20%)
Ion-exchange water: 200 parts

The above components are mixed together, and the resulting mixture is pulverized to 0.15 μm with Key Mill (continuous type) “KMC-3”. The solid content in the resulting dispersion liquid is adjusted to 20% by mass. Hereby, a nonfluorescent pigment dispersion liquid (1) is prepared.

TABLE 1

| Fluorescent | Fluorescent colorant | | | | | | | | |
|---|---|---|---|---|---|---|---|---|---|
| toner/ | | | | Volume | | | | Fluorescent | Flowtester |
| fluorescent | | | Content | average | Nonfluorescent colorant | | | emission | ½-drop |
| developer | | | A | particle | | | Content | wavelength | temperature |
| No. | Category | Type | [mass %] | size [nm] | Category | Type | [mass %] | [nm] | [° C.] |
| G1 | Aggregation- | PY101 | 10 | 250 | — | None | — | 520 | 120 |
| | induced emission | | | | | | | | |
| | colorant | | | | | | | | |
| G2 | Aggregation- | PY101 | 10 | 250 | Pigment | PG36 | 5 | 520 | 120 |
| | induced emission | | | | | | | | |
| | colorant | | | | | | | | |
| G3 | Aggregation- | PY101 | 10 | 250 | Pigment | PG7 | 3 | 520 | 120 |
| | induced emission | | | | | | | | |
| | colorant | | | | | | | | |
| G4 | Aggregation- | PY101 | 10 | 250 | Pigment | PB15:3 | 1 | 520 | 120 |
| | induced emission | | | | | | | | |
| | colorant | | | | | | | | |
| G5 | Aggregation- | PY101 | 1 | 250 | — | None | — | 520 | 120 |
| | induced emission | | | | | | | | |
| | colorant | | | | | | | | |
| G6 | Aggregation- | PY101 | 5 | 250 | — | None | — | 520 | 120 |
| | induced emission | | | | | | | | |
| | colorant | | | | | | | | |
| G7 | Aggregation- | PY101 | 15 | 250 | — | None | — | 520 | 120 |
| | induced emission | | | | | | | | |
| | colorant | | | | | | | | |
| G8 | Aggregation- | PY101 | 20 | 250 | — | None | — | 520 | 120 |
| | induced emission | | | | | | | | |
| | colorant | | | | | | | | |
| G9 | Aggregation- | PY101 | 10 | 100 | — | None | — | 520 | 120 |
| | induced emission | | | | | | | | |
| | colorant | | | | | | | | |
| G10 | Aggregation- | PY101 | 10 | 150 | — | None | — | 520 | 120 |
| | induced emission | | | | | | | | |
| | colorant | | | | | | | | |
| G11 | Aggregation- | PY101 | 10 | 500 | — | None | — | 520 | 120 |
| | induced emission | | | | | | | | |
| | colorant | | | | | | | | |
| G12 | Aggregation- | PY101 | 10 | 1000 | — | None | — | 520 | 120 |
| | induced emission | | | | | | | | |
| | colorant | | | | | | | | |
| G13 | Aggregation- | PY101 | 10 | 250 | — | None | — | 520 | 100 |
| | induced emission | | | | | | | | |
| | colorant | | | | | | | | |
| G14 | Aggregation- | PY101 | 10 | 250 | — | None | — | 520 | 90 |
| | induced emission | | | | | | | | |
| | colorant | | | | | | | | |
| G15 | Aggregation- | PY101-BF2 | 10 | 250 | — | None | — | 570 | 120 |
| | induced emission | | | | | | | | |
| | colorant | | | | | | | | |
| G16 | Aggregation- | PY101-BF2 | 10 | 250 | Pigment | PO38 | 5 | 570 | 120 |
| | induced emission | | | | | | | | |
| | colorant | | | | | | | | |
| G17 | Aggregation- | VSF-0-05 | 10 | 250 | — | None | — | 520 | 120 |
| | induced emission | | | | | | | | |
| | colorant | | | | | | | | |
| G18 | Aggregation- | VSF-0-05 | 10 | 250 | Pigment | PG36 | 4 | 520 | 120 |
| | induced emission | | | | | | | | |
| | colorant | | | | | | | | |

### Preparation of Fluorescent Toner S1 and Fluorescent Developer S1

A fluorescent toner S1 is prepared as in the preparation of the fluorescent toner G1, except that the fluorescent dye-colored particle dispersion liquid (1) described below is used. A developer S1 is prepared as in the preparation of the developer G1, except that the fluorescent toner S1 is used.

### Preparation of Fluorescent Dye-Colored Particle Dispersion Liquid (1)

Pigmented fluorescent dye (fluorescent material produced by pigmenting C. I. Basic Yellow 40, “NKW-3205E” produced by Nippon Fluorescent Chemical Co., Ltd.): 70 parts
Anionic surfactant “Neogen RK” produced by Dai-ichi Kogyo Seiyaku Co., Ltd.: 30 parts (solid component concentration: 20%)
Ion-exchange water: 200 parts

The above components are mixed together, and the resulting mixture is pulverized to 100 nm with Key Mill (continuous type) “KMC-3”. The solid content in the resulting dispersion liquid is adjusted to 20% by mass. Hereby, a fluorescent dye-colored particle dispersion liquid (1) is prepared.

### Preparation of Fluorescent Toners S2 to S15 and Fluorescent Developers S2 to S15

Fluorescent toners S2 to S15 are prepared as in the preparation of fluorescent toner S1, except that the type and content of the fluorescent colorant (i.e., the fluorescent dye) used, the use of a nonfluorescent colorant, and the type and content of the nonfluorescent colorant are changed as described in Table 2 and the molecular weight of the polyester resin included in the resin particle dispersion liquid is changed as needed. Developers S2 to S15 are prepared as in the preparation of the developer S1, except that the fluorescent toners S2 to S15 are used, respectively.

Note that, in the preparation of the fluorescent toners S2, S6, and S8, the above nonfluorescent pigment dispersion liquid (1) is used. In the preparation of the fluorescent toners S4, S10, and S12, a nonfluorescent pigment dispersion liquid (5) prepared as in the preparation of the nonfluorescent pigment dispersion liquid (1) except that the nonfluorescent green pigment used in the preparation of the nonfluorescent pigment dispersion liquid (1) is changed to “PR238” (C. I. Pigment Red 238, “Permanent Carmine 3810” produced by Sanyo Color Works, Ltd.) is used. In the preparation of the fluorescent toner S13, the nonfluorescent pigment dispersion liquid (3) is used.

TABLE 2

| Fluorescent | Fluorescent colorant | | | | | | | | |
|---|---|---|---|---|---|---|---|---|---|
| toner/ | | | | Molecular | | | | Fluorescent | Flowtester |
| fluorescent | | | Content | weight of | Nonfluorescent colorant | | | emission | ½-drop |
| developer | | | B | fluorescent | | | Content | wavelength | temperature |
| No. | Category | Type | [mass %] | dye | Category | Type | [mass %] | [nm] | [° C.] |
| S1 | Pigmented | Pigmented | 0.5 | 473 | — | None | — | 520 | 120 |
| | fluorescent | BY40 | | | | | | | |
| | dye | | | | | | | | |
| S2 | Pigmented | Pigmented | 0.5 | 473 | Pigment | PG36 | 4 | 520 | 120 |
| | fluorescent | BY40 | | | | | | | |
| | dye | | | | | | | | |
| S3 | Pigmented | Pigmented | 0.5 | 465 | — | None | — | 620 | 120 |
| | fluorescent | BR1:1 | | | | | | | |
| | dye | | | | | | | | |
| S4 | Pigmented | Pigmented | 0.5 | 465 | Pigment | PR238 | 3 | 620 | 120 |
| | fluorescent | BR1:1 | | | | | | | |
| | dye | | | | | | | | |
| S5 | Fluorescent | SG5 | 0.5 | 452 | — | None | — | 520 | 120 |
| | dye | | | | | | | | |
| S6 | Fluorescent | SG5 | 0.5 | 452 | Pigment | PG36 | 4 | 520 | 120 |
| | dye | | | | | | | | |
| S7 | Fluorescent | SY43 | 0.5 | 324 | — | None | — | 520 | 120 |
| | dye | | | | | | | | |
| S8 | Fluorescent | SY43 | 0.5 | 324 | Pigment | PG36 | 4 | 520 | 120 |
| | dye | | | | | | | | |
| S9 | Fluorescent | BR1:1 | 0.5 | 465 | — | None | — | 620 | 120 |
| | dye | | | | | | | | |
| S10 | Fluorescent | BR1:1 | 0.5 | 465 | Pigment | PR238 | 4 | 620 | 120 |
| | dye | | | | | | | | |
| S11 | Fluorescent | BR1:1 | 0.1 | 465 | — | None | — | 620 | 120 |
| | dye | | | | | | | | |
| S12 | Fluorescent | BR1:1 | 5 | 465 | Pigment | PR238 | 6 | 620 | 120 |
| | dye | | | | | | | | |
| S13 | Fluorescent | BR1:1 | 0.5 | 465 | — | None | — | 620 | 100 |
| | dye | | | | | | | | |
| S14 | Fluorescent | BR1:1 | 0.5 | 465 | Pigment | PR238 | 4 | 620 | 90 |
| | dye | | | | | | | | |
| S15 | Fluorescent | Fluorescent | 0.5 | 431 | Pigment | PB15:3 | 9 | 440 | 120 |
| | brightening | brightening | | | | | | | |
| | agent | agent 184 | | | | | | | |

Details of the abbreviations used in Tables 1 and 2 are as follows.

### Aggregation-Induced Emission Colorant

PY101: C. I. Pigment Yellow 101 “Radglo VSF-0-01” produced by Radiant Color, emission peak wavelength: 520 nm), aggregation-induced emission colorant
PY101-BF2: Boron difluoride derivative of C. I. Pigment Yellow 101 (emission peak wavelength: 570 nm), the compound illustrated below
VSF-0-05: “Radglo VSF-0-05” produced by Radiant Color, emission peak wavelength: 520 nm, IUPAC name: 1,2,3,4-tetrachloro-11H-isoindolo[2,1-a]benzimidazol-11-one, the compound illustrated below

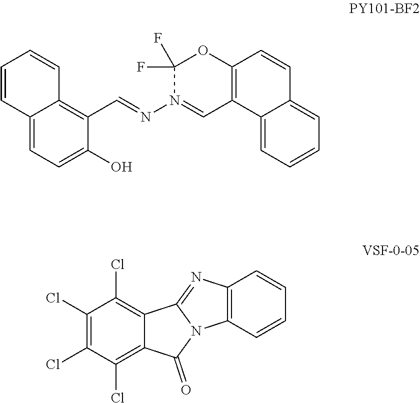

### Nonfluorescent Pigment

PG7: C. I. Pigment Green 7, “LIONOL GREEN 8390” produced by Toyocolor Co., Ltd., nonfluorescent pigment
PG36: C. I. Pigment Green 36, “LIONOL GREEN 8624” produced by Toyocolor Co., Ltd., nonfluorescent pigment.
PB15: 3: C. I. Pigment Blue 15:3, “LIONOL BLUE FG-7330” produced by Toyocolor Co., Ltd., nonfluorescent pigment.
PO38: C. I. Pigment Orange 38, “Graphtol Red HFG” produced by Clariant, nonfluorescent pigment
PR238: C. I. Pigment Red 238, “Permanent Carmine 3810” produced by Sanyo Color Works, Ltd., nonfluorescent pigment

### Pigmented Fluorescent Dye

Pigmented BY40: fluorescent material produced by pigmenting C. I. Basic Yellow 40, “NKW-3205E” produced by Nippon Fluorescent Chemical Co., Ltd., emission peak: 520 nm
Pigmented BR1:1: fluorescent material prepared by pigmenting C. I. Basic Red 1:1, “T-11 Aurora Pink” produced by DayGlo, emission peak wavelength: 620 nm

### Fluorescent Dye.

SG5: C. I. Solvent Green 5, “Oracet F Yellow 084” produced by BASF SE, emission peak: 520 nm.
SY43: C. I. Solvent Yellow 43, “PLAST Yellow DY-541” produced by Arimoto Chemical Industry Co., Ltd., emission peak: 520 nm.
BR1:1: C. I. Basic Red 1:1, “Rhodamine 590 Chloride” produced by Tokyo Chemical Industry Co., Ltd., emission peak: 620 nm
Fluorescent brightening agent 184: “Tinopal OB CO” produced by BASF SE, emission peak wavelength: 440 nm

### Examples 1 to 29 and Comparative Examples 1 to 8

Toner sets are prepared by combining the fluorescent toners and fluorescent developers prepared as described above with one another as described in Tables 3 and 4.

### Evaluations

One of the combinations of two colors of fluorescent developers described in Tables 3 and 4 is charged into a modification of “Revoria Press PC1120” produced by FUJIFILM Business Innovation Corp. in a chamber having a temperature of 25° C. and a humidity of 60% RH.

Onto an OS coated paper sheet “W127” produced by FUJIFILM Business Innovation Corp., a toner of the first color is transferred to form a lower layer (i.e., onto the surface of the paper sheet). Then, a toner of the second color is transferred onto the lower layer to form an upper layer. Subsequently, the toners are fixed at 180° C. to form a solid image that includes two colors of fluorescent toners which overlap each other. The deposition densities of toners of the first and second colors are both 4.0 g/m².

The L*, a*, and b* values of the solid image in the CIE1976L*a*b* color system are measured using a reflection spectrodensitometer “X-Rite 939” (aperture diameter: 4 mm) produced by X-Rite, Inc. at 10 positions randomly selected from the image, and the averages of the L*, a*, and b* values are calculated.

Subsequently, the printed material including the fluorescent image is stored for 1 month at a temperature of 55° C. and a humidity of 50%. Then, the image is again analyzed with “X-Rite 939” to calculate the average L*, a*, and b* values after storage.

The color difference ΔE of the fluorescent image included in the printed material which occurs during the storage is calculated using the formula below. The color difference ΔE is preferably minimized and is desirably 1.6 or less. Tables 3 and 4 list the results.

$$Δ E = \sqrt{{( {L}_{1} - {L}_{2} )}^{2} + {( {a}_{1} - {a}_{2} )}^{2} + {( {b}_{1} - {b}_{2} )}^{2}}$$

where L₁, a₁, and b₁ represent the L*, a*, and b* values of the fluorescent image of the printed material that has not been stored, and L₂, a₂, and b₂ represent the L*, a*, and b* values of the fluorescent image of the printed material that has been stored.

TABLE 3

| | Fluorescent toner/fluorescent | | | | | Fluorescent toner/fluorescent | | |
|---|---|---|---|---|---|---|---|---|
| | developer of first color | | | | | developer of second color | | |
| | | | Particle size | | | | | Particle size |
| | | | of aggregation- | Molecular | ½- | | | of aggregation- |
| | | | induced | weight of | Drop | | | induced |
| | | | emission | fluores- | temper- | | | emission |
| | | | colorant | cent | ature | | Fluorescent | colorant |
| | Type | Fluorescent colorant | [nm] | dye | [° C.] | Type | colorant | [nm] |
| Example 1 | G1 | Aggregation-induced emission colorant | 250 | — | 120 | G15 | Aggregation- | 250 |
| | | | | | | | induced emission | |
| | | | | | | | colorant | |
| Example 2 | G1 | Aggregation-induced emission colorant | 250 | — | 120 | S3 | Pigmented | — |
| | | | | | | | fluorescent dye | |
| Example 3 | G1 | Aggregation-induced emission colorant | 250 | — | 120 | S9 | Fluorescent dye | — |
| Example 4 | G2 | Aggregation-induced emission colorant | 250 | — | 120 | G16 | Aggregation- | 250 |
| | | | | | | | induced emission | |
| | | | | | | | colorant | |
| Example 5 | G2 | Aggregation-induced emission colorant | 250 | — | 120 | S4 | Pigmented | — |
| | | | | | | | fluorescent dye | |
| Example 6 | G2 | Aggregation-induced emission colorant | 250 | | 120 | S10 | Fluorescent dye | — |
| Example 7 | G3 | Aggregation-induced emission colorant | 250 | — | 120 | S10 | Fluorescent dye | — |
| Example 8 | G4 | Aggregation-induced emission colorant | 250 | — | 120 | S10 | Fluorescent dye | — |
| Example 9 | G17 | Aggregation-induced emission colorant | 250 | — | 120 | S9 | Fluorescent dye | — |
| Example 10 | G18 | Aggregation-induced emission colorant | 250 | — | 120 | S10 | Fluorescent dye | — |
| Example 11 | G1 | Aggregation-induced emission colorant | 250 | — | 120 | S15 | Fluorescent | — |
| | | | | | | | brightening agent | |
| Example 12 | G15 | Aggregation-induced emission colorant | 250 | — | 120 | S15 | Fluorescent | — |
| | | | | | | | brightening agent | |
| Example 13 | S3 | Pigmented fluorescent dye | — | 465 | 120 | G1 | Aggregation- | 250 |
| | | | | | | | induced emission | |
| | | | | | | | colorant | |
| Example 14 | S9 | Fluorescent dye | — | 465 | 120 | G1 | Aggregation- | 250 |
| | | | | | | | induced emission | |
| | | | | | | | colorant | |
| Example 15 | S15 | Fluorescent brightening agent | — | 431 | 120 | G1 | Aggregation- | 250 |
| | | | | | | | induced emission | |
| | | | | | | | colorant | |
| Example 16 | G5 | Aggregation-induced emission colorant | 250 | — | 120 | S9 | Fluorescent dye | — |
| Example 17 | G6 | Aggregation-induced emission colorant | 250 | — | 120 | S9 | Fluorescent dye | — |
| Example 18 | G7 | Aggregation-induced emission colorant | 250 | — | 120 | S9 | Fluorescent dye | — |
| Example 19 | G8 | Aggregation-induced emission colorant | 250 | — | 120 | S9 | Fluorescent dye | — |

| | Fluorescent toner/fluorescent | | | | | | |
|---|---|---|---|---|---|---|---|
| | developer of second color | | Difference | | | | Evalu- |
| | Molecular | ½- | in fluo- | | | | ation |
| | weight of | Drop | rescent | | | | Color |
| | fluores- | temper- | emission | Content | Content | | differ- |
| | cent | ature | wavelength | A | B | A > | ence |
| | dye | [° C.] | [nm] | [mass %] | [mass %] | B? | ΔE |
| Example 1 | — | 120 | 50 | 10 | — | — | 0.0 |
| Example 2 | 465 | 120 | 100 | 10 | 0.5 | Yes | 0.2 |
| Example 3 | 465 | 120 | 100 | 10 | 0.5 | Yes | 0.4 |
| Example 4 | — | 120 | 50 | 10 | — | — | 0.0 |
| Example 5 | 465 | 120 | 100 | 10 | 0.5 | Yes | 0.1 |
| Example 6 | 465 | 120 | 100 | 10 | 0.5 | Yes | 0.3 |
| Example 7 | 465 | 120 | 100 | 10 | 0.5 | Yes | 0.3 |
| Example 8 | 465 | 120 | 100 | 10 | 0.5 | Yes | 0.4 |
| Example 9 | 465 | 120 | 100 | 10 | 0.5 | Yes | 0.3 |
| Example 10 | 465 | 120 | 100 | 10 | 0.5 | Yes | 0.2 |
| Example 11 | 431 | 120 | 80 | 10 | 0.5 | Yes | 0.2 |
| Example 12 | 431 | 120 | 130 | 10 | 0.5 | Yes | 0.3 |
| Example 13 | — | 120 | 100 | 10 | 0.5 | Yes | 0.2 |
| Example 14 | — | 120 | 100 | 10 | 0.5 | Yes | 0.4 |
| Example 15 | — | 120 | 80 | 10 | 0.5 | Yes | 0.2 |
| Example 16 | 465 | 120 | 100 | 1 | 0.5 | Yes | 0.8 |
| Example 17 | 465 | 120 | 100 | 5 | 0.5 | Yes | 0.6 |
| Example 18 | 465 | 120 | 100 | 15 | 0.5 | Yes | 0.5 |
| Example 19 | 465 | 120 | 100 | 20 | 0.5 | Yes | 0.6 |

TABLE 4

| | Fluorescent toner/fluorescent | | | | | Fluorescent toner/fluorescent | | |
|---|---|---|---|---|---|---|---|---|
| | developer of first color | | | | | developer of second color | | |
| | | | Particle | | | | | Particle |
| | | | size of | | | | | size of |
| | | | aggregation- | Molecular | ½- | | | aggregation- |
| | | | induced | weight of | Drop | | | induced |
| | | | emission | fluores- | temper- | | | emission |
| | | | colorant | cent | ature | | Fluorescent | colorant |
| | Type | Fluorescent colorant | [nm] | dye | (° C.) | Type | colorant | [nm] |
| Example 20 | G1 | Aggregation-induced emission colorant | 250 | — | 120 | S11 | Fluorescent dye | — |
| Example 21 | G1 | Aggregation-induced emission colorant | 250 | — | 120 | S12 | Fluorescent dye | — |
| Example 22 | G9 | Aggregation-induced emission colorant | 100 | — | 120 | S9 | Fluorescent dye | — |
| Example 23 | G10 | Aggregation-induced emission colorant | 150 | — | 120 | S9 | Fluorescent dye | — |
| Example 24 | G11 | Aggregation-induced emission colorant | 500 | — | 120 | S9 | Fluorescent dye | — |
| Example 25 | G12 | Aggregation-induced emission colorant | 1000 | — | 120 | S9 | Fluorescent dye | — |
| Example 26 | G15 | Aggregation-induced emission colorant | 250 | — | 120 | S5 | Fluorescent dye | — |
| Example 27 | G15 | Aggregation-induced emission colorant | 250 | — | 120 | S7 | Fluorescent dye | — |
| Example 28 | G13 | Aggregation-induced emission colorant | 250 | — | 120 | S13 | Fluorescent dye | — |
| Example 29 | G14 | Aggregation-induced emission colorant | 250 | — | 90 | S14 | Fluorescent dye | — |
| Comparative Example 1 | S3 | Pigmented fluorescent dye | — | 465 | 120 | S1 | Pigmented | — |
| | | | | | | | fluorescent dye | — |
| Comparative Example 2 | S3 | Pigmented fluorescent dye | — | 465 | 120 | S5 | Fluorescent dye | — |
| Comparative Example 3 | S9 | Fluorescent dye | — | 465 | 120 | S6 | Fluorescent dye | — |
| Comparative Example 4 | S4 | Pigmented fluorescent dye | — | 465 | 120 | S2 | Pigmented | — |
| | | | | | | | fluorescent dye | — |
| Comparative Example 5 | S4 | Pigmented fluorescent dye | — | 465 | 120 | S6 | Fluorescent dye | — |
| Comparative Example 6 | S10 | Fluorescent dye | — | 465 | 120 | S6 | Fluorescent dye | — |
| Comparative Example 7 | S1 | Pigmented fluorescent dye | — | 473 | 120 | S15 | Fluorescent | — |
| | | | | | | | brightening | |
| | | | | | | | agent | |
| Comparative Example 8 | S5 | Fluorescent dye | — | 452 | 120 | S15 | Fluorescent | — |
| | | | | | | | brightening | |
| | | | | | | | agent | |

| | Fluorescent toner/fluorescent | | | | | | |
|---|---|---|---|---|---|---|---|
| | developer of second color | | Difference | | | | Evalu- |
| | Molecular | ½- | in | | | | ation |
| | weight of | Drop | fluorescent | | | | Color |
| | fluores- | temper- | emission | Content | Content | | differ- |
| | cent | ature | wavelength | A | B | A > | ence |
| | dye | [° C.] | [mm] | [mass %] | [mass %] | B? | ΔE |
| Example 20 | 465 | 120 | 100 | 10 | 0.1 | Yes | 0.9 |
| Example 21 | 465 | 120 | 100 | 10 | 5 | Yes | 1.1 |
| Example 22 | 465 | 120 | 100 | 10 | 0.5 | Yes | 0.9 |
| Example 23 | 465 | 120 | 100 | 10 | 0.5 | Yes | 0.5 |
| Example 24 | 465 | 120 | 100 | 10 | 0.5 | Yes | 0.4 |
| Example 25 | 465 | 120 | 100 | 10 | 0.5 | Yes | 0.7 |
| Example 26 | 452 | 120 | 50 | 10 | 0.5 | Yes | 0.4 |
| Example 27 | 324 | 120 | 50 | 10 | 0.5 | Yes | 0.9 |
| Example 28 | 465 | 100 | 100 | 10 | 0.5 | Yes | 0.8 |
| Example 29 | 465 | 90 | 100 | 10 | 0.5 | Yes | 1.2 |
| Comparative Example 1 | 473 | 120 | 100 | — | 0.5 | — | 1.8 |
| Comparative Example 2 | 452 | 120 | 100 | — | 0.5 | — | 2.0 |
| Comparative Example 3 | 452 | 120 | 100 | — | 0.5 | — | 2.3 |
| Comparative Example 4 | 473 | 120 | 100 | — | 0.5 | — | 1.8 |
| Comparative Example 5 | 452 | 120 | 100 | — | 0.5 | — | 1.9 |
| Comparative Example 6 | 452 | 120 | 100 | — | 0.5 | — | 2.2 |
| Comparative Example 7 | 431 | 120 | 80 | — | 0.5 | — | 1.7 |
| Comparative Example 8 | 431 | 120 | 80 | — | 0.5 | — | 2.0 |

In Tables 3 and 4, “Particle size of aggregation-induced emission colorant” is the volume average size of particles of the aggregation-induced emission colorant included in the toner.

In Tables 3 and 4, “½-Drop temperature” is a ½-drop temperature measured with a flow tester.

The results described in Tables 3 and 4 confirm that each of the toner sets prepared in Examples may reduce the color difference of an image formed using the toner set which occurs when the image is stored at high temperatures, compared with the toner sets prepared in Comparative Examples.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) A toner set including:
two colors of fluorescent toners,
wherein a difference between wavelengths of fluorescent light emitted by the two colors of fluorescent toners is 50 nm or more, and
at least one of the two colors of fluorescent toners includes only an aggregation-induced emission colorant serving as a fluorescent colorant.

(((2))) The toner set according to (((1))),
wherein a content A of the aggregation-induced emission colorant in the at least one of the two colors of fluorescent toners is 1% by mass or more and 20% by mass or less.

(((3))) The toner set according to (((2))),
wherein one of the two colors of fluorescent toners is a fluorescent toner including a fluorescent dye and free of the aggregation-induced emission colorant,
a content B of the fluorescent dye in the fluorescent toner including a fluorescent dye and free of the aggregation-induced emission colorant is 0.1% by mass or more and 5% by mass or less, and
the content A of the aggregation-induced emission colorant and the content B of the fluorescent dye satisfy A>B.

(((4))) The toner set according to any one of (((1))) to (((3))),
wherein the aggregation-induced emission colorant included in the at least one of the two colors of fluorescent toners has a volume average particle size of 100 nm or more and 1,000 nm or less.

(((5))) The toner set according to (((4))),
wherein the aggregation-induced emission colorant included in the at least one of the two colors of fluorescent toners has a volume average particle size of 150 nm or more and 500 nm or less.

(((6))) The toner set according to any one of (((1))) to
wherein one of the two colors of fluorescent toners is a fluorescent toner including a fluorescent dye and free of the aggregation-induced emission colorant, and
the fluorescent dye included in the fluorescent toner including a fluorescent dye and free of the aggregation-induced emission colorant has a molecular weight of 400 or more.

(((7))) The toner set according to any one of (((1))) to (((6))),
wherein ½-drop temperatures of the two colors of fluorescent toners, the ½-drop temperatures being measured with a flow tester, are 90° C. or more.

(((8))) An electrostatic image developer set including:
a first electrostatic image developer including one of the two colors of fluorescent toners included in the toner set according to any one of (((1))) to (((7))); and
a second electrostatic image developer including another of the two colors of fluorescent toners included in the toner set according to any one of (((1))) to (((7))).

(((9))) A toner cartridge set detachably attachable to an image forming apparatus, the toner cartridge set including:
a first toner cartridge including one of the two colors of fluorescent toners included in the toner set according to any one of (((1))) to (((7))); and
a second toner cartridge including another of the two colors of fluorescent toners included in the toner set according to any one of (((1))) to (((7))).

(((10))) A process cartridge detachably attachable to an image forming apparatus, the process cartridge including:
a first developing unit including the first electrostatic image developer included in the electrostatic image developer set according to (((8))); and
a second developing unit including the second electrostatic image developer included in the electrostatic image developer set according to (((8))).

(((11))) An image forming apparatus including:
a first image formation unit that forms a first fluorescent image with one of the two colors of fluorescent toners included in the toner set according to any one of (((1))) to (((7)));
a second image formation unit that forms a second fluorescent image with another of the two colors of fluorescent toners included in the toner set according to any one of (((1))) to (((7)));
a transfer unit that transfers the first and second fluorescent images to a recording medium; and
a fixing unit that fixes the first and second fluorescent images to the recording medium.

(((12))) An image forming method including:
a first image formation step of forming a first fluorescent image with one of the two colors of fluorescent toners included in the toner set according to any one of (((1))) to (((7)));
a second image formation step of forming a second fluorescent image with another of the two colors of fluorescent toners included in the toner set according to any one of (((1))) to (((7)));
a transfer step of transferring the first and second fluorescent images to a recording medium; and
a fixing step of fixing the first and second fluorescent images to the recording medium.

(((13))) A printed material including:
a recording medium;
a first fluorescent image including one of the two colors of fluorescent toners included in the toner set according to any one of (((1))) to (((7))); and
a second fluorescent image including another of the two colors of fluorescent toners included in the toner set according to any one of (((1))) to (((7))), the second fluorescent image being arranged to overlap at least a portion of the first fluorescent image.

What is claimed is:

1. A toner set comprising:
two colors of fluorescent toners,
wherein a difference between wavelengths of fluorescent light emitted by the two colors of fluorescent toners is 50 nm or more, and
at least one of the two colors of fluorescent toners includes only an aggregation-induced emission colorant serving as a fluorescent colorant.

2. The toner set according to claim 1,
wherein a content A of the aggregation-induced emission colorant in the at least one of the two colors of fluorescent toners is 1% by mass or more and 20% by mass or less.

3. The toner set according to claim 2,
wherein one of the two colors of fluorescent toners is a fluorescent toner including a fluorescent dye and free of the aggregation-induced emission colorant,
a content B of the fluorescent dye in the fluorescent toner including a fluorescent dye and free of the aggregation-induced emission colorant is 0.1% by mass or more and 5% by mass or less, and
the content A of the aggregation-induced emission colorant and the content B of the fluorescent dye satisfy A>B.

4. The toner set according to claim 1,
wherein the aggregation-induced emission colorant included in the at least one of the two colors of fluorescent toners has a volume average particle size of 100 nm or more and 1,000 nm or less.

5. The toner set according to claim 4,
wherein the aggregation-induced emission colorant included in the at least one of the two colors of fluorescent toners has a volume average particle size of 150 nm or more and 500 nm or less.

6. The toner set according to claim 1,
wherein one of the two colors of fluorescent toners is a fluorescent toner including a fluorescent dye and free of the aggregation-induced emission colorant, and
the fluorescent dye included in the fluorescent toner including a fluorescent dye and free of the aggregation-induced emission colorant has a molecular weight of 400 or more.

7. The toner set according to claim 1,
wherein ½-drop temperatures of the two colors of fluorescent toners, the ½-drop temperatures being measured with a flow tester, are 90° C. or more.

8. An electrostatic image developer set comprising:
a first electrostatic image developer including one of the two colors of fluorescent toners included in the toner set according to claim 1; and
a second electrostatic image developer including another of the two colors of fluorescent toners included in the toner set according to claim 1.

9. An electrostatic image developer set comprising:
a first electrostatic image developer including one of the two colors of fluorescent toners included in the toner set according to claim 2; and
a second electrostatic image developer including another of the two colors of fluorescent toners included in the toner set according to claim 2.

10. An electrostatic image developer set comprising:
a first electrostatic image developer including one of the two colors of fluorescent toners included in the toner set according to claim 3; and
a second electrostatic image developer including another of the two colors of fluorescent toners included in the toner set according to claim 3.

11. An electrostatic image developer set comprising:
a first electrostatic image developer including one of the two colors of fluorescent toners included in the toner set according to claim 4; and
a second electrostatic image developer including another of the two colors of fluorescent toners included in the toner set according to claim 4.

12. An electrostatic image developer set comprising:
a first electrostatic image developer including one of the two colors of fluorescent toners included in the toner set according to claim 5; and
a second electrostatic image developer including another of the two colors of fluorescent toners included in the toner set according to claim 5.

13. An electrostatic image developer set comprising:
a first electrostatic image developer including one of the two colors of fluorescent toners included in the toner set according to claim 6; and
a second electrostatic image developer including another of the two colors of fluorescent toners included in the toner set according to claim 6.

14. An electrostatic image developer set comprising:
a first electrostatic image developer including one of the two colors of fluorescent toners included in the toner set according to claim 7; and
a second electrostatic image developer including another of the two colors of fluorescent toners included in the toner set according to claim 7.

15. A toner cartridge set detachably attachable to an image forming apparatus, the toner cartridge set comprising:
a first toner cartridge including one of the two colors of fluorescent toners included in the toner set according to claim 1; and
a second toner cartridge including another of the two colors of fluorescent toners included in the toner set according to claim 1.

16. A process cartridge detachably attachable to an image forming apparatus, the process cartridge comprising:
a first developing unit including the first electrostatic image developer included in the electrostatic image developer set according to claim 8; and
a second developing unit including the second electrostatic image developer included in the electrostatic image developer set according to claim 8.

17. An image forming apparatus comprising:
a first image formation unit that forms a first fluorescent image with one of the two colors of fluorescent toners included in the toner set according to claim 1;
a second image formation unit that forms a second fluorescent image with another of the two colors of fluorescent toners included in the toner set according to claim 1;
a transfer unit that transfers the first and second fluorescent images to a recording medium; and
a fixing unit that fixes the first and second fluorescent images to the recording medium.

18. An image forming method comprising:
a first image formation step of forming a first fluorescent image with one of the two colors of fluorescent toners included in the toner set according to claim 1;
a second image formation step of forming a second fluorescent image with another of the two colors of fluorescent toners included in the toner set according to claim 1;
a transfer step of transferring the first and second fluorescent images to a recording medium; and
a fixing step of fixing the first and second fluorescent images to the recording medium.

19. A printed material comprising:
a recording medium;
a first fluorescent image including one of the two colors of fluorescent toners included in the toner set according to claim 1; and
a second fluorescent image including another of the two colors of fluorescent toners included in the toner set according to claim 1, the second fluorescent image being arranged to overlap at least a portion of the first fluorescent image.
